(19) United States
(12) Patent Application Publication
(10) Pub. No.: US 2026/0080419 A1
(43) Pub. Date: Mar. 19, 2026

(54) SYSTEMS AND METHODS FOR ASSET VALIDATION AND DETECTION OF MISUSE AND COUNTERFEITING USING MULTIMODAL TAG DATA

(71) Applicant: LocatorX, Inc., Kissimmee, FL (US)

(72) Inventor: Jeff Kase, Bar Harbor, ME (US)

(73) Assignee: LocatorX, Inc., Kissimmee, FL (US)

(21) Appl. No.: 19/197,256

(22) Filed: May 2, 2025

Related U.S. Application Data
(60) Provisional application No. 63/666,129, filed on Jun. 29, 2024.

(51) Int. Cl. G06Q 30/018; G06K 19/06; G06K 19/07

(52) U.S. Cl. CPC G06Q 30/0185; G06K 19/06037; G06K 19/0723

(57) ABSTRACT

Systems and methods for verifying an asset using a multimodal tag scanned by a gateway device. The gateway device extracts one or more of: a hash code, an asset identifier, and a verification URL from the tag or application memory, and generates a POST request including the hash code and one or more contextual parameters such as an authentication token, geolocation value, or time-based authentication code. The POST request is transmitted to a server, which compares the hash code with reference values and validates the contextual parameters to determine a verification result. The result is transmitted to the gateway device and the server may control asset access or trigger alerts. The server may log verification attempts, classify asset status, and evaluate scan feasibility based on historical data. Assets may be marked as genuine, moved, stolen, counterfeited, or unauthorized based on spatiotemporal and user-specific analysis.

### CROSS REFERENCE TO RELATED APPLICATIONS

This application claims the benefit of U.S. Provisional Application Number 63/666,129, filed Jun. 29, 2024, and entitled SYSTEM AND METHOD FOR VALIDATING AN ASSET, the entire contents of which are incorporated herein by reference.

### FIELD OF THE INVENTION

The present invention relates generally to systems and methods for verifying physical assets, and more particularly to asset verification using multimodal tags and contextual validation through gateway devices and server-based authentication. The invention further relates to real-time and historical verification analysis using parameters such as hash codes, user identity, geolocation, and time-based authentication for detecting counterfeiting, unauthorized access, asset relocation, and misuse.

### BACKGROUND

Asset verification technologies have become an important part of modern supply chains, retail operations, and security systems. Various methods are employed to authenticate physical items, track their movement, and validate ownership or originality. Among these, QR codes are widely used due to their convenience, flexibility, efficiency, and low cost of implementation. QR codes are simple to generate, and may be printed on all kinds of mediums, whether on paper, on packaging materials, integrated into labels, or even applied directly onto the surface of a product, allowing for quick access to web-based resources, product information, or validation services through a simple scan using a smartphone or dedicated scanner. Therefore, they may also be used to track the location of the product.

However, while easy and inexpensive to produce, QR codes also present certain security vulnerabilities and risks related to counterfeiting. That is, QR codes are essentially patterns of black squares on a white background, making them easy to replicate or alter with minimal technical expertise. An attacker or counterfeiter can create a look-alike QR code with manipulated content to deceive users by redirecting them to fraudulent websites or presenting manipulated content. These cloned QR code copies may be placed on counterfeit products or unauthorized replicas, and misleading consumers, resellers, and even service providers into believing that the products they buy are genuine and have been verified via the QR code scans.

In addition to QR code vulnerabilities, other existing asset verification methods, such as serial number verification, holographic labels, barcodes, RFID tags, and manual documentation, exhibit their own deficiencies. Serial numbers printed on assets can be easily copied or photographed and reused across counterfeit goods. Holographic labels, while somewhat resistant to duplication, can still be imitated with sophisticated printing methods, and often require specialized lighting or angles for validation, making quick field verification impractical. RFID tags, although more secure, are susceptible to being cloned if the communication protocol is not adequately encrypted or if static identifiers are broadcasted without authentication mechanisms. Manual methods of verification relying on paper-based certificates or visual inspection are inherently subject to human error, loss, forgery, and fraud.

A further challenge faced by current asset verification methods relates to the problem of theft and unauthorized use of assets. When physical assets such as valuable goods, industrial equipment, or electronics are stolen, existing tracking mechanisms often fail to distinguish between authorized and unauthorized handling. Stolen goods may retain original tags, serial numbers, or QR codes, making it difficult to determine legitimacy solely based on a visual scan or database lookup. Without real-time, authenticated validation tied to both the asset and the current holder's credentials, stolen or lost assets may continue to circulate in secondary markets, undermining brand reputation, causing financial losses, and posing security risks in sensitive industries.

Unauthorized use of an asset presents another critical concern. Even if an asset remains within an organization's control, improper or unauthorized usage—such as the use of medical devices by unqualified personnel, or the deployment of restricted industrial equipment by unauthorized contractors—can result in regulatory violations, equipment damage, liability issues, or safety hazards. Existing asset tagging and tracking systems typically lack mechanisms to authenticate user authority at the point of access or use, leading to gaps in asset security and accountability.

In view of the above discussion, there remains a need for improved techniques for asset verification and authentication. There remains a need for solutions that are resistant to counterfeiting, capable of verifying both the authenticity of the asset and the authorization of its handler or user, and capable of detecting anomalies such as unauthorized movement, theft, or improper use of assets.

### SUMMARY OF THE INVENTION

Accordingly, the present invention provides systems, methods, and apparatus for validating an asset through the use of a multimodal tag comprising a visible indicator and a wireless communication device. The system enables robust authentication of a physical asset by verifying both visible and wireless identifiers associated with the asset against securely stored reference data. The multimodal tag affixed to or associated with the asset may include a visible marker, such as a certified QR (CQR) code or barcode, and a wireless communication device, such as a Near Field Communication (NFC) tag, RFID chip, Bluetooth transceiver, ultrawideband device, or a random pattern-based security feature. Each component of the multimodal tag may store or point to unique data identifying the asset, and the system validates the authenticity of the asset based on comparison between captured data and secured records maintained by a remote server.

In some embodiments, a visible marker includes a CQR code which encodes a Uniform Resource Locator (URL) comprising an asset identifier and a cryptographic hash code associated with the asset. Upon scanning the CQR code with a mobile gateway device, such as a smartphone or tablet, the mobile device retrieves the URL and sends a validation request to a cloud-based server. The validation request may include information such as the asset identifier, hash code, authentication token identifying the user, and geolocation value or information (e.g., latitude and longitude). The server verifies the authenticity of the visible marker by comparing the received hash code against a pre-stored qr_hash value associated with the asset in a database.

Additionally, in certain embodiments, the wireless communication device embedded in the multimodal tag stores information separately from the visible marker. For example, an NFC device embedded within the asset may store a unique identifier (UUID) and a separate cryptographic hash (nfc_hash). When the mobile gateway device is placed in proximity to the asset, it wirelessly retrieves the UUID and nfc_hash from the NFC device. The mobile device then transmits these values to the server for independent verification against the corresponding stored records. This two-mode (visible and wireless) validation approach enables a layered verification process that significantly reduces the risk of counterfeiting or unauthorized replication.

In further embodiments, the system may include an external identification (ID) device, separate from the CQR label and NFC device, affixed to, or associated with, the asset. The external ID device may be implemented as a 2-dimensional or 3-dimensional barcode, an iQR code, an RFID tag with extended memory, or a device incorporating a random nanoparticle pattern. The external ID provides an additional, independent verification channel. Upon scanning the external ID, the mobile gateway device may retrieve a unique identifier associated with the asset and send it to the server for cross-verification against a record of authorized identifiers. In some embodiments, the server may use external ID scans to detect duplication of identifiers or unexpected movement of assets across locations.

In accordance with some embodiments of the invention, the validation process may be tied not only to the identity of the asset, but also to the credentials or authorization level of the user performing the scan. For example, prior to initiating the validation process, the mobile gateway device may require the user to authenticate via biometric credentials, such as fingerprint or facial recognition, or via a secure password login. Upon successful authentication, the device may attach an authentication token to the validation request sent to the server. This approach enables validation not only of the asset, but also of the user's authorization to access, handle, or use the asset.

In certain embodiments, the system further provides location-based validation to detect anomalous behavior. When an asset is scanned, the geolocation of the scanning event may be recorded and compared to expected or authorized locations stored in the system. If an asset that is supposed to remain within a particular perimeter (such as a warehouse, hospital, or secure facility) is scanned outside the permitted area, the system may flag the event as a potential theft or unauthorized movement. Similarly, multiple scans of the same asset from geographically distant locations within an implausibly short time frame may indicate that the asset has been cloned or counterfeited, thereby enabling real-time alerts to be triggered.

The invention further contemplates embodiments in which the multimodal tag supports pairing or linking of multiple assets. For example, a first asset, such as a medical instrument, and a second asset, such as a portable monitor, may each have independent multimodal tags. A user may scan both assets in succession, and the system may create an association record linking the two assets for future inventory, tracking, and usage validation purposes. Such pairing may be particularly useful in industries requiring strict management of equipment sets, such as hospitals, defense facilities, or manufacturing plants.

In certain implementations, the mobile gateway device may also be configured to periodically prompt users to rescan assets, particularly where periodic validation is required for compliance, warranty maintenance, or asset usage tracking. For example, a mobile app on the gateway device may display a message such as “It's been a while since you scanned Asset XYZ123” to remind the user to perform a fresh scan and validation of the asset. This feature provides continued monitoring of asset status and discourages unauthorized substitution or misplacement of assets over time.

In accordance with yet other embodiments, the server may be configured to maintain detailed scan history logs for each asset. The scan history may include timestamps, scanned location coordinates, scanning user identifiers, and validation outcomes (match or non-match). In the event of discrepancies, such as scans occurring in unexpected locations or non-matching hash validations, the system may provide visual indicators or alerts to administrators for further investigation. Such scan history information may also support audits, investigations, warranty claims, regulatory reporting, or internal accountability measures.

In some embodiments, a multimodal asset verification may be achieved by scanning a single visible marker, such as a Certified QR (CQR) code affixed to an asset, in combination with an authentication token associated with the user operating the scanning device. Upon scanning the CQR code using a mobile gateway device, such as a smartphone, the mobile device may retrieve encoded information from the CQR code, such as a Uniform Resource Locator (URL) comprising an asset identifier and a hash code. The mobile device may also generate or retrieve an authentication token corresponding to the currently authenticated user of the device, wherein the authentication token may be generated by prior user login, biometric validation, or other secure credentialing mechanisms.

The mobile device may then transmit the scanned CQR data and the user's authentication token to a cloud-based server for verification. The server may validate the authenticity of the asset by comparing the received hash code against a securely stored reference hash associated with the asset in a database. In parallel, the server may authenticate the user's authorization to access or handle the asset by validating the authentication token against a user authorization database. If both the asset verification and the user authentication succeed, the server may confirm that the asset is genuine and is being accessed by an authorized individual. Conversely, if either the asset verification or the user authentication fails, the system may trigger a warning, denial of access, or further investigation.

For example, a high-value electronic device, such as a company-issued laptop or a medical diagnostic device, may have a CQR code label affixed to its casing. A field technician assigned to service the device may be required to scan the CQR code using a corporate mobile application, which enforces biometric login. Upon scanning, the system validates both the asset's authenticity and the technician's service authorization before allowing further interaction with the device, updating service logs, or granting access to restricted software features.

In other embodiments, in addition to transmitting the CQR code data and the user authentication token, the mobile device may also capture and transmit the geolocation data of the scanning event to the server. The location data may include parameters such as latitude, longitude, and optionally a timestamp, allowing the server to correlate the scan location with pre-established authorized locations for the asset. This additional layer of multimodal verification strengthens the asset validation process, particularly for assets that are location-sensitive or subject to movement restrictions.

For example, an industrial generator or large construction equipment, such as a crane, may be tagged with a CQR label. The system may expect that the asset be scanned and validated only within a designated construction site. When a contractor scans the CQR code before operating the equipment, the mobile device transmits the scan data along with the contractor's authentication token and current geolocation. The server verifies the authenticity of the asset, validates the contractor's authorization, and checks that the scanning event occurred within the geofenced perimeter associated with the construction site. If the asset is scanned at a location outside the permitted area, the system may flag the event, restrict further operation of the equipment, or generate an alert to administrative personnel.

Similarly, for sensitive medical assets, such as a mobile X-ray machine intended for use only within a specific hospital facility, location-based verification ensures that the asset is operated only within authorized premises. If a scan occurs at a different geographic location, such as at an unapproved clinic or off-site location, the system can instantly detect the anomaly, thus helping to prevent theft, unauthorized relocation, or misuse of critical assets.

The present invention thus provides a secure, scalable, and flexible solution for asset validation, offering improvements over existing techniques vulnerable to counterfeiting, unauthorized access, theft, and misuse. By utilizing multimodal tags combining both visible and wireless authentication factors, incorporating user credential verification, employing real-time cloud-based validation, and enabling intelligent anomaly detection, the system greatly enhances the reliability and trustworthiness of asset verification processes across a wide range of industries.

### BRIEF DESCRIPTION OF THE DRAWINGS

FIG. 1 is a diagram of an object validation system, according to an embodiment of the present disclosure.

FIG. 1A is a diagram illustrating an exemplary asset labeled with a multimodal tag, according to some embodiments of the present disclosure.

FIG. 1B illustrates an exemplary system and method for validating an asset using a gateway device to scan a multimodal tag affixed to the asset, according to some embodiments of the present disclosure.

FIGS. 1C-1D illustrate exemplary components of a tag, and how a POST request is generated and transmitted from a mobile device to a server for asset validation, according to some embodiments of the present disclosure.

FIG. 1E illustrates an exemplary gateway device executing an asset verification application presenting multiple selectable options for initiating different types of tag-based and user-authenticated verification workflows.

FIG. 1F is a flowchart illustrating an exemplary asset verification process using a multimodal tag scanned by a gateway device, in accordance with some embodiments of the present disclosure.

FIG. 1G illustrates an exemplary verification table generated by a server, in accordance with some embodiments of the present disclosure.

FIG. 2 is an exemplary diagram showing the details of the gateway, according to an embodiment of the present disclosure.

FIG. 3A is an exemplary flowchart of a method of validating an object, according to an embodiment of the present disclosure.

FIG. 3B is a continuation of the flowchart of the method of validating the object shown in FIG. 3A, according to an embodiment of the present disclosure.

FIG. 4 is a diagram of components of a server, according to an example of the present disclosure.

FIG. 5 illustrates an example of tag-based asset validation, in which identical tags affixed to different assets are scanned by multiple users using mobile devices, in accordance with some embodiments of the present disclosure.

FIG. 6 illustrates an example of asset verification in which a mobile device prompts for biometric authentication from a user during or after scanning a tag affixed to an asset, thereby enabling a secondary layer of user-specific validation.

FIG. 7 illustrates an example of a periodic asset verification prompt generated on a user device, reminding the user to rescan a previously validated asset to ensure continued monitoring and authorized use.

FIG. 8 illustrates an example of pairing two or more devices with each other using a mobile device, wherein the pairing is based on multimodal verification of tags associated with each device, in accordance with some embodiments of the present disclosure.

FIG. 9 illustrates an exemplary system and method for validating an asset through scans performed by multiple users using separate mobile devices, in accordance with some embodiments of the present disclosure.

FIG. 10 illustrates an exemplary system and method for verifying an asset that is location-bound, in accordance with some embodiments of the present disclosure.

FIGS. 11A-11B illustrate exemplary verification tables stored and maintained by a server, showing validation outcomes based on user identity, location, and time of scan, in accordance with various embodiments of the present disclosure.

FIGS. 12A-12B illustrate exemplary method steps that may be executed in some embodiments of the present invention.

### DETAILED DESCRIPTION

The present invention provides systems, methods, and apparatuses for secure, flexible, and context-aware verification of assets using multimodal tags in conjunction with a gateway device and a server-based authentication framework. The invention enables asset validation based on one or more identifiers encoded in tags such as Certified QR codes, NFC tags, and external ID devices, while incorporating user identity, location data, and historical verification patterns to determine the authenticity and integrity of the asset in question.

In one embodiment, a multimodal tag affixed to an asset may contain a hash code, a URL, and optionally an asset ID or other metadata. Upon scanning the tag using a gateway device, such as a smartphone or tablet running a verification application, the device extracts data from the tag and composes a POST request directed to a remote verification server. The POST request may include a verification URL, the hash code extracted from the tag, and additional data such as user identity tokens, GPS coordinates, and time-based one-time passwords (TOTP) for enhanced security.

The server receives the POST request and validates the received hash code against stored records. In some configurations, the hash code itself may be encoded with the asset ID and verification URL. The server may evaluate the authenticity of the tag, the correctness of the associated user identity, the validity of the user's current location, and any embedded time-based or behavioral constraints to determine the outcome of the verification.

In certain embodiments, the system supports various scan modes, including auto-detection of tag type, manual scan of Certified QR, NFC, or external ID tags, and two-factor verification mechanisms. Two-factor verification may involve scanning multiple tag types (e.g., QR and NFC), or a combination of one tag scan along with user authentication, such as biometrics, user ID, or geolocation checks.

The gateway device may locally store authorized hash code pairs to support offline validation or repeat verifications. In such embodiments, if a scan matches a stored hash code from a previously verified session, temporary access may be granted even in the absence of live server communication. Alternatively, the gateway device may receive TOTP codes from the server for session-based authorization.

The server may maintain structured verification tables that log each scan attempt and its parameters, including asset ID, hash comparison outcomes, user identity, location status, and final system-determined asset status. The asset status may include labels such as “Genuine,” “Counterfeited,” “Asset Moved,” or “Stolen” based on rule-based evaluations.

In advanced embodiments, an AI engine operating on the server may analyze usage patterns, scan timings, and geographic movement to detect anomalies. For example, if the same user is recorded scanning the same asset from distant locations within an implausible time frame, the server may flag the attempt and deny access, suspecting counterfeit activity or misuse.

Organizations may configure assets as either location-bound or freely movable. For location-bound assets, the system restricts access to predefined geofenced zones. For movable assets, the system uses logic to evaluate plausibility of asset movements over time and geography.

In case of failed verifications, anomalies, or suspected security breaches, the system may escalate alerts to authorized personnel, such as administrators or organizational stakeholders. These alerts may include incident details and may trigger automated lockdowns or audit requirements.

The invention further provides comprehensive audit logging, policy enforcement, and administrative tooling for managing large fleets of assets in industries such as logistics, healthcare, government, education, and field service. By combining multiple verification dimensions-tag authenticity, user identity, location, time, and behavior-the system delivers a robust, scalable, and tamper-resistant solution for verifying and managing physical assets.

In some embodiments, a system is provided for verifying an asset using a multimodal tag that is scanned by a gateway device and authenticated by a server. The process begins with the gateway device receiving scan data from a multimodal tag affixed to or associated with the asset. The multimodal tag may include a Certified QR (CQR) code, an NFC tag, a barcode, or any other electronically readable identifier, and may store one or more data elements such as a hash code, an asset identifier, and a verification Uniform Resource Locator (URL). The scan data may be captured through the gateway device's camera, NFC reader, or barcode scanner, and is processed in real time by a verification application running on the gateway device.

Once the scan data is received, the gateway device extracts the available components from the tag. In some configurations, the tag may encode all three values-the hash code, asset ID, and URL-as discrete fields. In other cases, the tag may only contain a hash code that itself is a compound value derived from the asset ID and URL through a deterministic encoding algorithm. If the URL is not present in the scan data, the gateway device retrieves a preconfigured verification URL from the local memory of the verification application. This fallback facilitates that the server endpoint for validation is always present, even if the scanned tag omits it for storage efficiency or security.

With the necessary data elements in hand, the gateway device constructs a POST request. This request includes the verification URL as the destination endpoint, and appends the extracted hash code as a primary validation parameter. Additionally, the gateway device may include one or more contextual authentication values, such as a user authentication token associated with the logged-in user of the device, a geolocation value captured from the device's GPS module, and a time-based authentication code such as a time-based one-time password (TOTP). The POST request structure is formatted according to a predefined API specification recognized by the server.

Once the POST request is constructed, the gateway device transmits it to the server using a secure network protocol. The server receives and parses the POST request, extracting the hash code and any contextual authentication data. The server then compares the received hash code with one or more reference hash values stored in a verification database. These reference values were previously generated and stored during asset registration or tag provisioning and may be indexed by asset ID, organization, or deployment location.

In addition to hash comparison, the server validates contextual parameters. The authentication token is checked against an access control list or user management system to confirm that the requester is an authorized user. The geolocation value is evaluated against any geographic restrictions associated with the asset, such as facility boundaries, designated deployment zones, or mobile usage policies. The time-based authentication code, if present, is validated based on a shared secret and current time window, verifying that the scan occurred within a synchronized and secure time frame.

Based on the outcomes of the hash comparison and contextual validation, the server determines a verification result. A successful verification occurs when the hash code matches a reference hash and all contextual parameters are valid. In response to a successful verification, the server transmits a response message back to the gateway device. This response includes an explicit confirmation of successful verification and may also include full asset metadata, such as the asset's name, category, last known location, assigned organization, maintenance status, and operational constraints.

In case of unsuccessful verification-due to a hash mismatch, invalid user authentication, unauthorized location, or expired time-based code-the server transmits a corresponding failure message. This failure message may include diagnostic information explaining the failed parameter (e.g., “Unauthorized user,” “Invalid hash,” or “Scan outside permitted zone”), enabling the gateway device to prompt corrective action.

In all cases, the server logs the verification attempt in a persistent audit log. The log entry includes the time-stamp of the verification attempt, the asset identifier extracted from the hash or scan data, a unique identifier associated with the gateway device (e.g., IMEI, MAC address, or application instance ID), and the final verification result (e.g., success, hash mismatch, unauthorized user, or asset moved). These log entries enable historical tracking of scan activity, help identify patterns of misuse, and form the basis for compliance reporting and future anomaly detection.

For example, consider an asset used in a distributed healthcare system, such as a portable defibrillator tagged with a CQR and an NFC chip. A technician scans the asset at a remote clinic using a company-issued mobile device. The scan triggers a POST request that includes the hash code, the technician's user ID, GPS coordinates of the scan, and a TOTP. The server validates the hash against its database, confirms that the user is currently logged into the enterprise application, and verifies that the location matches an approved clinic zone. The result is successful, and the server sends back the asset's maintenance status, operational manual, and timestamp of the last validation. Simultaneously, the entire event is logged with all associated metadata for later review.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a system and method for validating an object (i.e., an asset or a product). This may be done by multi-factor validation of Certified QR (CQR) labels, external Identification devices, and Near Field Communication (NFC) tags.

In recent years, NFC has evolved from Radio Frequency ID (RFID) technology, to enable secure wireless connectivity between two devices, with related exchange of data. As applied to a smartphone or a tablet, NFC allows for the secure and rapid exchange of information between two devices, simply by approaching (via Peer-to-Peer) in proximity.

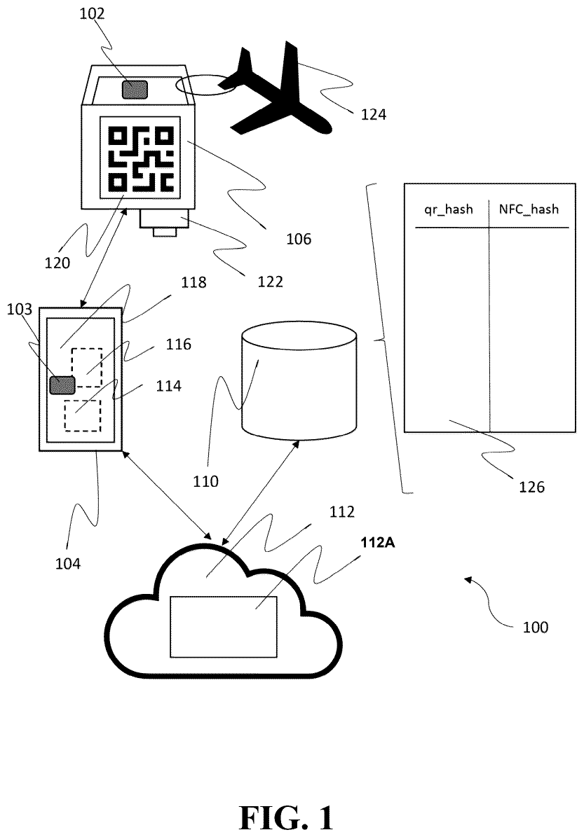

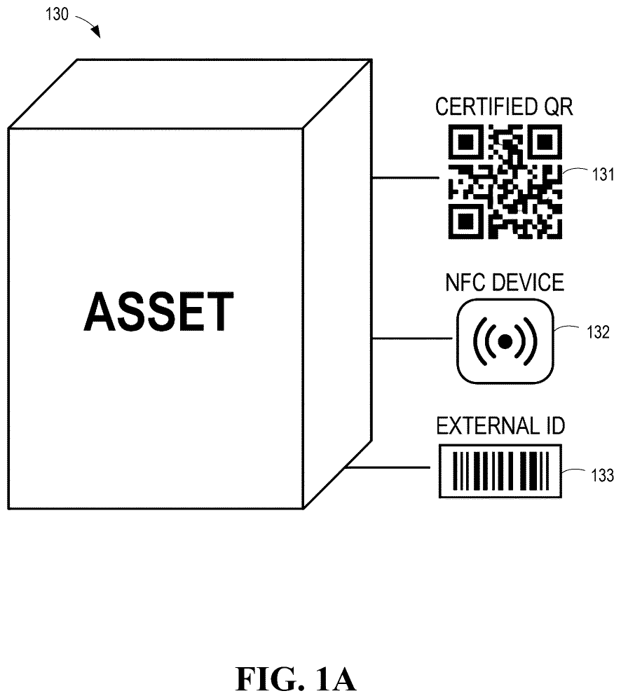

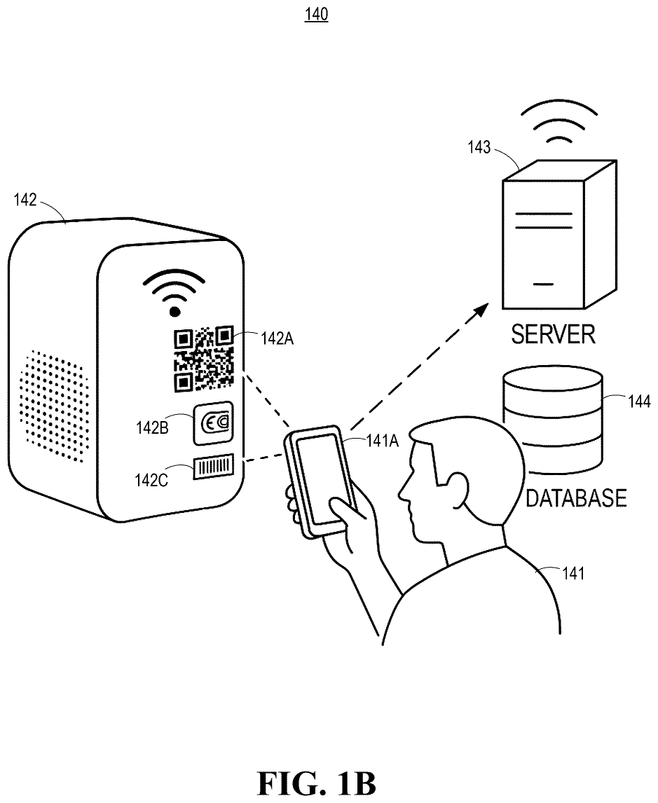

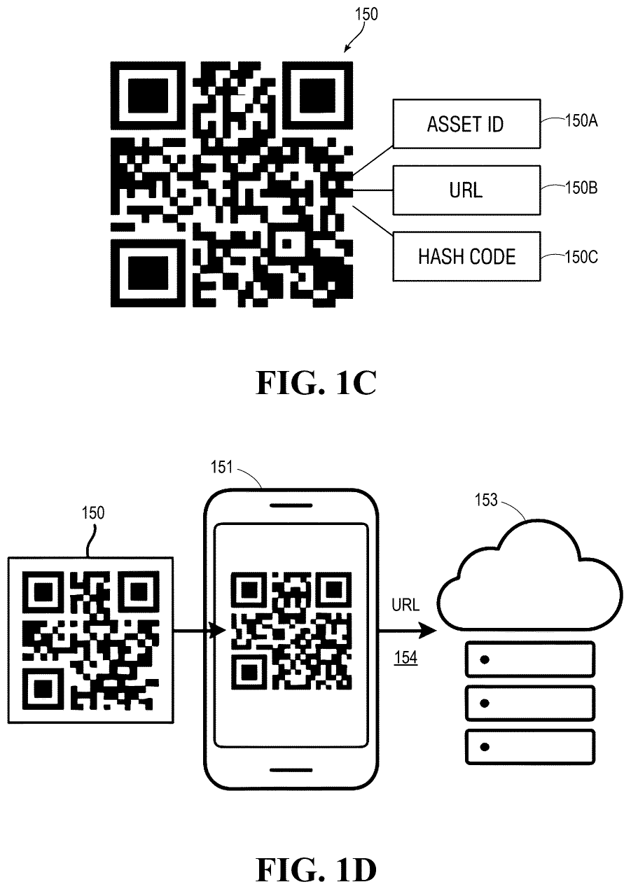

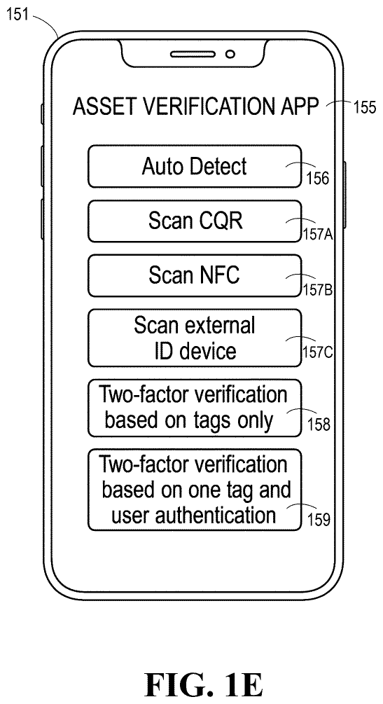

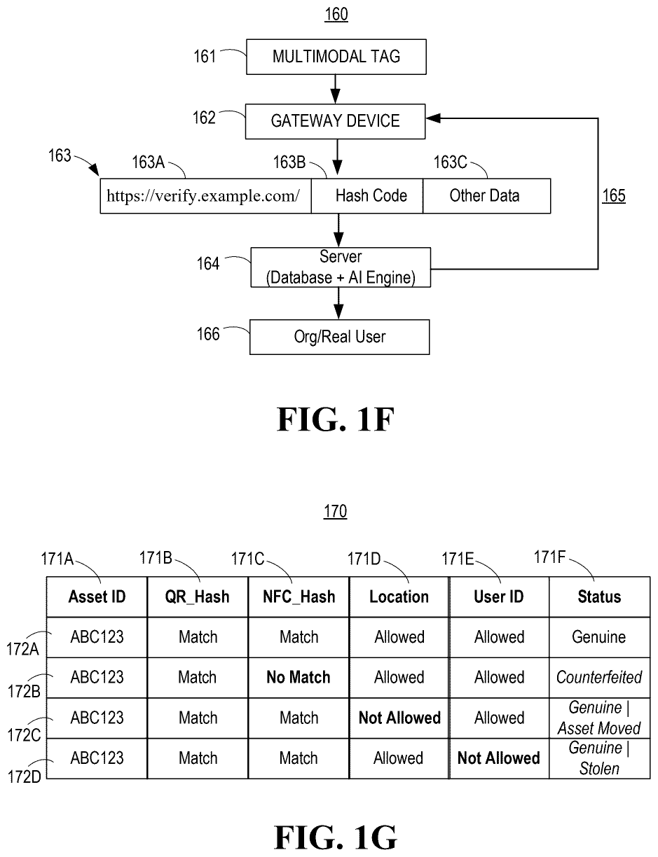

FIG. 1 is a diagram of an object validation system 100 in which systems and/or methods described herein may be implemented. As shown in FIG. 1, the system 100 may include one or more elements 102-124, as described in more detail below. The system 100 may include a server (e.g., endpoint) 112A, a gateway 104, a multimodal tag 106, and a database 110. Devices and/or elements of the system 100 may interconnect via wired connections and/or wireless connections. The system 100 may also include a hash table 126 that stores one or more hash pairs for verification.

The server 112A may be deployed in a cloud computing platform 112, which may be a public cloud, a private cloud, or a hybrid cloud. The server 112A itself may be implemented as a physical machine, a virtual machine, or a combination thereof. The cloud computing platform 112 may include computing hardware, a resource management component, a host operating system (OS), and/or one or more virtual computing systems.

The resource management component may perform virtualization (e.g., abstraction) of the computing hardware to create the one or more virtual computing systems. Using virtualization, the resource management component enables a single computing device (e.g., a computer, a server, and/or the like) to operate like multiple computing devices, such as by creating multiple isolated virtual computing systems from the computing hardware of the single computing device. In this way, the computing hardware can operate more efficiently, with lower power consumption, higher reliability, higher availability, higher utilization, greater flexibility, and lower cost than using separate computing devices.

The computing hardware includes hardware and corresponding resources from one or more computing devices. For example, the computing hardware may include hardware from a single computing device (e.g., a single server) or from multiple computing devices (e.g., multiple servers), such as multiple computing devices in one or more data centers. The computing hardware may include one or more processors, one or more memories, one or more storages, and/or one or more networking components. Examples of a processor, a memory, a storage, and a networking component (e.g., a communication component) are described elsewhere herein.

The resource management component includes a virtualization application (e.g., executing on hardware, such as the computing hardware) capable of virtualizing the computing hardware to start, stop, and/or manage the one or more virtual computing systems. For example, the resource management component may include a hypervisor (e.g., a bare-metal or Type 4 hypervisor, a hosted or Type 2 hypervisor, and/or the like) or a virtual machine monitor, such as when the virtual computing systems are virtual machines. Additionally, or alternatively, the resource management component may include a container manager, such as when the virtual computing systems are containers. In some implementations, the resource management component executes within and/or in coordination with a host operating system.

A virtual computing system includes a virtual environment that enables cloud-based execution of operations and/or processes described herein using computing hardware. As shown, the virtual computing system may include a virtual machine, a container, a hybrid environment that includes a virtual machine and a container, and/or the like. A virtual computing system may execute one or more applications using a file system that includes binary files, software libraries, and/or other resources required to execute applications on a guest operating system (e.g., within the virtual computing system) or the host operating system.

The network includes one or more wired and/or wireless networks. For example, the network may include a cellular network, a Public Land Mobile Network (PLMN), a Local Area Network (LAN), a Wide Area Network (WAN), a private network, the Internet, and/or the like, and/or a combination of these or other types of networks. The network enables communication among the devices of the system 100.

The gateway 104 may be part of a mobile, handheld device (i.e., mobile device), such as a smart phone, a tablet, a wearable computing device (e.g., a smart-watch, a pair of virtual reality or augmented reality glasses), or portable microcomputer and the like. The gateway may include a processor 114, a memory 116, and a display 118. The gateway 104 may also contain an NFC reader device 103 and a camera or image scanner to scan QR codes.

That is, in an embodiment, the gateway includes one or more devices capable of receiving, generating, storing, processing, and/or providing information, as described elsewhere herein. The gateway may include a communication device and/or a computing device. For example, the gateway may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The multimodal tag 106 is attached to an object 124 (e.g., a physical item, an asset, product, or part) that is being tracked, and includes a wireless communication device, such as, by way of non-limiting example, a Near Field Communication (NFC) device 102 that further includes a certified QR (CQR) code label 120 and an external identification (ID) device 122. The multimodal tag 106 may provide two or more independently verifiable data elements. Other wireless communication devices are also within the scope of other inventions, such as, for example, a Bluetooth, BLE, ultrawideband, random pattern of printed particles, such as nanoparticle inks, or other nonvisible wireless communication modality.

The NFC device 102 is typically a passive device that is embedded in an antenna, and is part of an NFC system, which also includes an NFC reader device (e.g., 103 i.e., NFC chip or NFC chipset) and an NFC communication chip. That is, NFC Devices 102 may include RFID transponders that operate at 13.56 MHz. They are tiny chips (integrated circuits) connected to an antenna. The chip has a unique ID and a part of rewritable memory. The antenna allows the chip to interact with an NFC reader device 103. In recent years, NFC Devices 102 have developed to the point where one may write information onto the available memory of an NFC Device 102. This information can be easily read (and executed) by an NFC reader device 103.

The NFC Device 102 may respond to commands from the NFC reader device 103, and may store strings of data. In an embodiment, the NFC Device 102 may include a memory of about 144 bytes that is adapted to store one of an identification of the object 124, is of an ISO Format of ISO15693, and is one of an NFC-V or a TYPE-5 NFC. Also, the stored data may include an object ID number and an NFC hash.

The NFC reader device 103 is a silicon component or integrated circuit (IC) that facilitates short-range, wireless communication between devices. It is the active part of the NFC system that processes information, can read/write data, and sends commands to the NFC Device 102. When connected to the NFC Device 102, the NFC chip enables secure interactions within close proximity (within about 10-20 cm), and may retrieve the string information stored on the NFC Device 102. NFC chips allow devices to exchange data wirelessly when they are near each other. In an embodiment, the NFC chip may be embedded in the gateway (e.g., in a hand-held mobile device).

The NFC communication chip coordinates communication between the NFC reader device 103 and the NFC Device 102.

The NFC Device 102 allows for a low-cost digital representation of the object's digital fingerprint. Unlike CQR codes alone, which can be easily copied via a scanner or a camera and reprinted, NFC Devices 102 may be much more secure. Unlike Bluetooth or other communication methods, NFC does not require a search and pair procedure, which allows for a much faster connection without requiring manual configuration or special software. In an embodiment, the NFC Device 102 may support the ISO 15693 standard, which defines an ability to restrict read and write access and assign passwords for access.

Also, the NFC Device 102 may have capacity to store more than label information about the tag 106, but may also store NFC data required to decrypt the NFC reader device 103 data.

The CQR code label 120 is a specialized 2-dimensional (2D) barcode that can be printed on paper and coupled with the NFC Device 102. In an embodiment, the CQR code label 120 may be directly printed on the NFC Device 102. When scanned by a mobile device, the CQR code label 120 provides string information (e.g., a URL) in the form of a qr_hash that allows for access to additional information related to the object 124, including validation data, or a full document provided on a website. The CQR code label 120 enhances document security and may verify the authenticity of the user.

Along with the combined, simultaneous use of the CQR code label 120 and the NFC Device 102, the system 100 may function as an intelligent QR (iQR) and provide for two independent validation and verification mechanisms, which results in greater security.

The external ID device 122 may be an additional 2D or 3-dimensional (3D) barcode apart from the above-described CQR code label 120 that is coupled to the NFC Device 102. In an embodiment the external ID device 122 may be an RFID that stores from 64-bit to 2 kilobyte of data or an ultra-high-frequency tag. Alternatively, the external ID device 122 may further include a battery to power the external ID device 122. In this case, more than 100 kilobyte of information may be stored within the external ID device 122.

Similar to the case with CQR code label 120, when scanned by a mobile device, the external ID device (122) may also provide string information (e.g., a URL) in the form of an external ID unique (at the object level) within the organization that is performing the scan that allows for access to additional information related to the object 124, including validation data, or a full document provided on a website. The external ID device (122) may further enhance document security and may verify the authenticity of the user.

That is, the external ID device 122 provides for an alternative two-factor validation route from the COR label validation, when used with the NFC Device 102. However, when used in conjunction with the CQR code label 120 and the NFC Device 102, a more secure three-factor verification process may be achieved.

The database 110 may be adapted to store information (e.g., object information) 126 about the object 124. The information 126 may be arranged to include two cryptographic data columns that are generated during a Principal Component Analysis (PCA) process. These two columns may include a qr_hash column accessible by a scan of the CQR code label 120, and an nfc_hash column separate from the qr_hash column that may be accessed upon proximate contact (or tap) between the NFC Device 102 and the NFC reader device 103. The creation of the two independent columns allows for two independent validation and verification mechanisms, which, when combined simultaneously, allow for greater security and prevention from counterfeiting of the validation devices.

In an embodiment, the nfc_hash column may store a unique password for each object 124, along with temporal data including the last cycle count on the NFC reader device 103 or the NFC Device 102 (i.e., how many read/writes).

Referring now to FIG. 1A, an exemplary asset 130 is labeled with a multimodal tag, according to some embodiments of the present disclosure. The asset 130 may be a physical object, item, article, component, piece of equipment, or other tangible structure intended to be verified, tracked, or monitored for security, authenticity, inventory management, usage validation, or compliance control. The asset 130 may be movable or stationary in nature, and may be selected from a wide variety of domains including, but not limited to, consumer electronics, industrial machinery, retail goods, pharmaceuticals, aerospace components, defense equipment, and medical devices. In one example, the asset 130 may comprise a portable medical scanner, an industrial valve, a packaged consumer product, or an electronic control unit. In another example, the asset 130 may be a fixed infrastructure element, such as a hospital bed, warehouse conveyor, or mounted telecommunications switch, requiring local tagging for traceability and restricted operational use.

The multimodal tag associated with the asset 130 may comprise one or more components designed to uniquely identify and validate the authenticity of the asset 130 during scanning or inspection. As shown in FIG. 1A, the multimodal tag may include a Certified QR (CQR) code label 131, a Near Field Communication (NFC) device 132, and an external identification (ID) device 133. Each of these elements may be physically or digitally associated with the asset 130 and may operate independently or in combination with one another to provide different modalities of validation. The components of the multimodal tag may be mounted on the outer surface of the asset 130, embedded within its housing, attached as part of a label, molded into the asset's exterior, or affixed through adhesives, brackets, or mechanical fasteners, depending on the form factor, material, and function of the asset 130.

The Certified QR code label 131 may be a two-dimensional barcode that is optically scannable using a gateway, for example, a smartphone, tablet, camera-enabled terminal, or dedicated QR reader. The CQR code label 131 may encode digitally signed data, such as a Uniform Resource Locator (URL), a unique asset identifier, and a cryptographic hash that can be resolved via a validation server. In some embodiments, the data encoded in the CQR code label 131 may be pre-generated by a central registration authority and may include additional elements such as manufacturing batch code, warranty identifier, model number, encryption key reference, or expiration date metadata. Upon scanning, the gateway device may extract the information from the CQR code label 131 and initiate a remote validation request via a secure network, sending the extracted data to a backend server that verifies the authenticity of the code by comparing it to a corresponding database record. The CQR code label 131 may be printed using tamper-evident ink, heat-fused into a polycarbonate label, laser-etched onto a metallic surface, or engraved onto the body of the asset 130, based on durability requirements. In one embodiment, a luxury wristwatch may have the CQR code label 131 printed on the backplate, whereas in another embodiment, a handheld testing instrument may include the CQR code label 131 under a protective glass layer near its display interface.

The NFC device 132 shown in FIG. 1A may comprise a wireless communication element that operates in accordance with ISO/IEC 14443, ISO/IEC 15693, or other NFC-compatible standards. The NFC device 132 may include an antenna, a memory chip, and passive or semi-passive circuitry that allows data to be transmitted wirelessly upon proximity-based activation by an NFC reader. The NFC device 132 may store various data fields, such as a Universally Unique Identifier (UUID), a dynamic or static authentication hash, encrypted asset metadata, digital certificates, or updateable event logs. In certain implementations, the NFC device 132 may support password-protected memory access, write-once fields, or hash-based challenge response authentication to prevent cloning or unauthorized replication. The NFC device 132 may be embedded within the asset 130, laminated into its internal shell, or adhered externally as a tag covered by a waterproof or impact-resistant housing. For example, an NFC device 132 may be molded inside the plastic enclosure of a smart thermostat, or inserted under the vinyl surface of an automotive part. The proximity-based nature of the NFC device 132 allows for short-range verification that is difficult to spoof from a distance, making it a valuable authentication layer.

The external ID device 133 may be a supplementary identification feature that provides an additional or alternate scannable format. The external ID device 133 may include a barcode, matrix code, iQR, alphanumeric serial number, colorimetric label, holographic strip, watermark-encoded image, or nanoparticle ink pattern. In the example shown, the external ID device 133 is represented as a one-dimensional barcode label. The external ID device 133 may store a locally unique identifier assigned to the asset 130 within a facility, organization, or logistics network, and may also include coded manufacturing or tracking metadata. In some embodiments, the external ID device 133 may be a passive RFID tag with long-range readability, a 3D printed pattern that exhibits a specific light-reflection signature, or a visual code that is read by specialized optical scanners in controlled environments. This component may be used in cases where fast scanning of a high volume of assets is required, or where compatibility with legacy equipment or commercial logistics systems is desired. The external ID device 133 may be attached to the asset 130 using adhesives, clipped to a mounting bracket, or printed directly onto product packaging or casing. In one example, a warehouse storage bin may include the external ID device 133 on its outer wall, while in another example, a telecommunications module may have the external ID device 133 etched into a removable service plate.

The combination of the CQR code label 131, the NFC device 132, and the external ID device 133 provides multiple layers of independent validation mechanisms for asset 130. These can be used independently or collectively in a multimodal authentication protocol to assess asset authenticity, determine access eligibility, verify chain-of-custody, or record audit trails. For example, in a high-security environment such as an airport or a pharmaceutical distribution center, both the CQR code label 131 and the NFC device 132 may be scanned together, and cross-validation may be performed between the values retrieved from each. This approach allows detection of tag tampering or partial replication attempts. Additionally, systems can be configured to request user credentials or biometric verification alongside the tag scan to confirm authorized user interaction. In another embodiment, the location of the scan may be logged with the multimodal tag's data, and compared with a known authorized use zone. If a medical diagnostic machine labeled with a tag like that shown in FIG. 1A is scanned at a location not registered to any authorized clinic, the system may trigger an alert or lock asset functionality until administrative review.

In some embodiments, the server-side system receiving the scan data from any of the tag components (CQR code label 131, NFC device 132, or external ID device 133) may generate a real-time validation report. Such a report may include timestamp of the scan, asset ID, matched hash result, scan origin (e.g., gateway device ID or user profile), and a validity status. The scan history for each asset 130 may be stored in a secure database, with each validation logged as a separate event. Over time, this builds a comprehensive traceability record for each asset 130 across its lifecycle. The multimodal tag shown in FIG. 1A therefore supports a range of applications including supply chain traceability, anti-counterfeiting protection, secure user access, maintenance logging, and regulatory compliance across diverse industries.

Referring now to FIG. 1B, an exemplary system and method (140) is illustrated for validating an asset 142 using a gateway device 141A to scan a multimodal tag comprising multiple components 142A, 142B, and 142C affixed to or integrated with the asset 142, according to some embodiments of the present disclosure. The user 141 is shown operating the gateway device 141A, which may be implemented as a mobile computing device such as a smartphone, tablet, wearable smart device, or handheld scanner. The gateway device 141A may be equipped with one or more sensors, including a camera, a Near Field Communication (NFC) reader, a barcode scanner, GPS module, and a wireless transceiver configured for communication with a cloud server 143 over a secure communication channel, such as HTTPS, WebSocket, or MQTT. The gateway device 141A may execute a mobile or embedded application configured to scan and interpret multimodal tags attached to physical assets, initiate authentication requests, receive validation responses, and render the asset status to the user 141.

In the example shown in FIG. 1B, the asset 142 may be any physical product or equipment tagged for the purpose of validation, authentication, or access control. The asset 142 may be movable or stationary in nature, and may range from high-value consumer goods, such as electronics, watches, or fashion items, to industrial tools, leased equipment, or medical devices. The asset 142 is tagged with a multimodal identification structure comprising a Certified QR (CQR) code 142A, an NFC device 142B, and an external identification (ID) element 142C. The CQR code 142A may contain encoded information such as a Uniform Resource Locator (URL), a unique asset identifier, and a cryptographic hash. The NFC device 142B may store a Universally Unique Identifier (UUID) and a hash value associated with the asset 142, and may be readable via short-range wireless communication. The external ID element 142C may comprise a barcode, alphanumeric label, RFID tag, or other visible identifier that can be scanned using compatible equipment. Each of the tag components 142A-142C may independently or collectively enable the validation of the asset 142.

In operation, the user 141 scans one or more components of the multimodal tag using the gateway device 141A. The gateway device 141A may automatically detect available scan modes or prompt the user 141 to manually select a scanning method. Upon scanning, the gateway device 141A may extract encoded information and generate a validation request comprising data such as the asset identifier, one or more hash values, user credentials or authentication tokens, device metadata, and geolocation coordinates (geolocation value). This validation request may be transmitted wirelessly to the cloud server 143 for analysis. In some embodiments, the scanning application on the gateway device 141A may locally validate digital signatures associated with the scanned data, but final authentication may be carried out on the cloud server 143 to compare hash values and assess scanning context.

In some embodiments, the gateway device 141A may itself determine which component of the multimodal tag (142A-142C) has been scanned based on signal type, data structure, or input method. For example, if the gateway device 141A receives scanned data via an optical camera and the data conforms to a Quick Response (QR) code format, the scanning application may classify the input as originating from the Certified QR code 142A. Alternatively, if the scanned data is received wirelessly through an NFC interface and contains a UUID and associated hash pattern, the gateway device 141A may classify the input as originating from the NFC device 142B. Likewise, if the input is received through a barcode scanner or linear code reader, the application may categorize the source as the external ID 142C. This classification may be automatically recorded along with the scanned payload and used to annotate the validation request sent to the cloud server 143. In some implementations, this allows the gateway device 141A to apply different rules or pre-processing steps based on the identified scan source, such as adjusting decoding logic, hash algorithm selection, or formatting of the outbound payload. Additionally, this feature may enable auditing of tag component usage, supporting analytics such as frequency of use per modality, failure rates associated with a specific tag type, or detection of tag substitution if an expected modality is consistently missing or replaced.

The cloud server 143, as shown in FIG. 1B, may be a distributed computing system or a dedicated backend server operated and controlled by an organization, such as the original manufacturer, licensor, or authorized seller of the asset 142. The cloud server 143 may maintain a connection to a database 144 (verification database), which stores reference records including known asset identifiers, corresponding QR hash values, NFC hash values, external ID records, product specifications, geographic usage zones, and historical scan events. Upon receiving the scan data from the gateway device 141A, the cloud server 143 may compare the received hash codes and asset identifiers with the records stored in the database 144 to determine whether the asset 142 is authentic. Additionally, the server 143 may verify whether the user 141 or device 141A is authorized to access the asset 142, based on pre-defined usage rules or credentials.

In some embodiments, the cloud server 143 may be configured to analyze geolocation data associated with the scan event and compare it with expected or permitted asset locations stored in the database 144. For example, if the asset 142 is intended for use within a specific geographic boundary, such as a hospital, manufacturing site, or retail outlet, and the scan occurs outside that boundary, the system may log the event as a potential deviation or unauthorized movement. The organization operating the cloud server 143 may define such geofencing parameters and use the scan history to detect unusual movement patterns. For example, if an industrial pump tagged with the multimodal tag 142A-142C is found to be scanned across different countries within an implausible time frame, the server 143 may flag the asset 142 as potentially cloned, counterfeited, or stolen.

The scanning history stored in the database 144 may also be used to generate audit trails for compliance and monitoring. Each scan entry may include data such as scan time, scanning user identity, gateway device metadata, matched hash values, validation result, and asset status. In another example, if a consumer scans the asset 142 before purchasing it at a retail outlet, the system may record the scan as a validation event and associate the purchase location with the asset record. If the same asset (e.g., same tag) is scanned again in another territory shortly thereafter, such as in an unauthorized resale zone or through an unapproved distributor, the system may flag the duplication and notify the manufacturer. Thus, the organization operating the cloud server 143 may use the collected scan data to detect parallel imports, track unauthorized distribution channels, identify counterfeit insertions in supply chains, and investigate warranty fraud.

In other embodiments, the server 143 may offer real-time feedback to the user 141 via the gateway device 141A, presenting a validation result indicating whether the asset 142 is verified, counterfeit, relocated, expired, or otherwise non-compliant. The system 140 may be integrated with additional enterprise services such as inventory control systems, service dispatch platforms, compliance enforcement engines, and consumer engagement tools. For example, upon successful validation of the asset 142, the system may offer the user 141 access to product manuals, maintenance history, warranty status, or a digital ownership certificate. This interoperability allows manufacturers and asset custodians to build trusted networks of physical asset validation and to maintain full visibility over product authenticity and usage across distributed environments.

Referring now to FIGS. 1C-1D, the figures illustrate exemplary components of a tag and how a POST request is generated and transmitted from a mobile device to a server for asset validation, according to some embodiments of the present disclosure. FIG. 1C depicts a tag 150, which for illustrative purposes is represented as a two-dimensional barcode (e.g., a QR code), but in actual implementation may take various forms including a Certified QR (CQR) code, a Near Field Communication (NFC) tag, a barcode, a matrix code, an external ID device, or any other encoded information carrier capable of being scanned by a gateway device. The tag 150 may be printed on, embedded into, or affixed to a physical asset, object, or product. In some embodiments, the tag 150 may be generated and encoded by a centralized registration authority or authorized organization responsible for asset authentication. The tag 150 may encode one or more data elements including but not limited to an asset identifier 150A, a Uniform Resource Locator (URL) 150B, and a hash code 150C. The asset identifier 150A may be a unique alphanumeric or hexadecimal value that corresponds to a registered asset in a remote or local database, such as “XYZ12345678” or “A45D3F8B2C.” The URL 150B may link to a verification endpoint hosted by a validation server or organization and may include query parameters such as the asset identifier or timestamp. For example, the URL 150B may be structured as “https://verify.example.com/check?id=XYZ12345678.” The hash code 150C may be a cryptographic digest (e.g., SHA-256 or SHA-512) computed over one or more asset-specific elements, including but not limited to the asset identifier, manufacturer code, timestamp, or location stamp, and may serve to validate the integrity and authenticity of the tag data.

In some embodiments, one or both of the asset identifier 150A and the URL 150B may be embedded within the hash code 150C either in whole or in part, thereby concealing the underlying identifiers from the plain data string within the tag 150. This method allows for obfuscation and tamper resistance, where an unauthorized party reading the tag 150 is unable to reverse-engineer the asset identifier or endpoint URL directly from the encoded pattern. Instead, only the hash code 150C is made visible, and upon scanning, the gateway device performs a secure request to a remote server that decodes or validates the embedded structure. In some embodiments, the hash code 150C may be computed using a combination of a fixed input (e.g., asset ID, manufacturing lot number) and a dynamic input (e.g., generation timestamp, serial sequence, or random salt). This technique provides enhanced protection against replication or cloning of tags, particularly in high-value product authentication scenarios such as pharmaceutical packaging, luxury goods, government-labeled instruments, or distributed high-security equipment. Additionally, the use of a hash-based approach allows for validation without exposing internal mapping structures or asset registration logic to the public domain, preserving backend security and integrity.

FIG. 1D depicts a gateway device 151 scanning the tag 150 and triggering the transmission of a URL 154 to a cloud server 153 for verification. The gateway device 151 may be any scanning-capable user device such as a smartphone, tablet, dedicated handheld scanner, wearable device, or augmented reality headset. The gateway device 151 may run a validation software application or web-based interface configured to scan, decode, and process the tag 150. Upon successfully scanning the tag 150 using optical sensors, NFC readers, or barcode scanners, the gateway device 151 may extract encoded data and generate a validation request to be transmitted to the server 153 over a network, such as the Internet, an intranet, a mobile data network, or a proprietary wireless mesh. In one embodiment, the extracted URL 150B from the tag 150 may be invoked directly as a GET or POST request to the endpoint specified within the tag, thereby forming URL 154. In another embodiment, the extracted hash code 150C may be used to construct a structured JSON payload or API call to a designated endpoint of the server 153, which then parses the input, locates the corresponding asset record, and returns the validation outcome to the gateway device 151. The server 153 may be a remote validation platform, organizational asset tracking engine, manufacturer-controlled database, or third-party verification service. In some embodiments, the request may include metadata such as the scanning user's credentials, geolocation data of the scan event, a timestamp, and device-specific identifiers. The server 153 may analyze the validity of the hash, cross-reference it with asset registration entries, check usage permissions, and compare scan context with known constraints (e.g., authorized usage locations, allowed user roles, or access periods).

In certain implementations, upon successful validation, the server 153 may return to the gateway device 151 a detailed asset profile, including product information, certification records, maintenance history, owner data, and validation confidence score. The gateway device 151 may render a validation result in real time to the scanning user, such as “Asset Verified,” “Hash Mismatch,” “Asset Relocated,” or “Access Restricted.” In other embodiments, the scanning and validation flow may be integrated with broader enterprise systems such as ERP (Enterprise Resource Planning), CRM (Customer Relationship Management), or SCM (Supply Chain Management) modules, where each successful scan logs into an audit trail or inventory management system. For example, a logistics technician scanning a tag 150 on a pallet of goods may automatically trigger inventory updates or delivery confirmations. In another example, a consumer scanning a tag 150 on a retail product may trigger the download of warranty details or promotional content. Thus, FIGS. 1C-1D illustrate a flexible, extensible, and secure framework for tag-based asset validation and lifecycle traceability using hybrid encoding, cryptographic verification, and remote backend integration.

Referring now to FIG. 1E, the exemplary gateway device 151 is configured to execute an asset verification application 155, the asset verification application 155 presenting multiple selectable options for initiating different types of tag-based and user-authenticated verification workflows, in accordance with some embodiments of the present disclosure. The gateway device 151 may be implemented as a smartphone, handheld scanner, tablet, or wearable computing device capable of communicating with physical tags and backend servers.

As illustrated, the asset verification application 155 displays a plurality of selectable options, including Auto Detect 156, Scan CQR 157A, Scan NFC 157B, Scan external ID device 157C, Two-factor verification based on tags only 158, and Two-factor verification based on one tag and user authentication 159. These options are configured to enable various workflows that support one or more verification layers, improving asset security, traceability, and fraud prevention.

The Auto Detect option 156 enables the gateway device 151 to initiate a passive scan for any detectable tag in the surrounding area. The tag may be a visible QR-based tag, a near-field NFC component, or an embedded external ID tag detectable via camera, RFID, or another optical scanner. Once a tag is detected, the application 155 automatically determines the type of tag by analyzing the data format and invokes the corresponding backend validation process.

For example, if the tag scanned through Auto Detect 156 is a Certified QR (CQR) code embedded with a URL and hash, the application 155 may extract the embedded data and send a POST request to a verification server. The POST request may contain the asset ID, tag hash, timestamp, and optionally device metadata for validation.

Alternatively, if the tag detected is an NFC tag, the gateway device 151 may retrieve stored identifiers and embedded hash values via wireless communication protocols. This data is then packaged into a POST request and transmitted to the server without requiring manual tag-type selection by the user.

The Auto Detect functionality 156 simplifies the scanning process and is particularly useful in environments where multiple tag types coexist. For example, a maintenance technician operating in a warehouse may encounter various tagged equipment, and Auto Detect 156 enables seamless verification of each asset without manual mode-switching.

The Scan CQR option 157A allows the user to initiate a manual scan of a Certified QR tag affixed to an asset. This mode may be ideal when the tag type is known in advance, such as during asset onboarding, inspection, or regular validation cycles.

Upon selecting Scan CQR 157A, the application 155 activates the gateway device's 151 camera, optical scanner, or imaging module to capture the QR code. The decoded data may include asset identifiers, digital signatures, and URLs pointing to verification endpoints. This data is processed and sent to the server for validation.

The Scan NFC option 157B permits scanning of embedded or attached near-field communication tags. When selected, the application 155 engages the device's NFC module and begins a polling cycle for tags within range. The tags may contain static or dynamically generated identifiers, hash values, and tag-specific metadata.

The NFC scan mode 157B is especially effective in environments requiring contactless interaction. For example, in sterile hospital environments or areas with heavy machinery, NFC scanning allows personnel to validate assets without requiring line-of-sight or physical contact.

The Scan external ID device option 157C enables scanning of tags other than QR or NFC, such as barcodes, proprietary ID patterns, RFID chips, or even optically recognized device engravings. The system can be configured to recognize custom encoding formats.

When option 157C is selected, the application 155 prompts the user to use an auxiliary scanning peripheral or the onboard camera to capture the external ID tag. Once scanned, the application 155 translates the encoded values and sends them to the server for validation.

Option 158 presents a two-factor verification mode that uses multiple tag types for asset validation. Under this mode, the user must scan two distinct tags associated with the asset to complete the verification process.

For example, a user may first scan a CQR tag using option 157A and then be required to scan an NFC tag using 157B within a defined time interval. Only if both scans are completed within the acceptable time window will the system generate a successful verification response.

The two-factor tag verification mode 158 strengthens security by cross-validating two independent identifiers. This reduces the risk of spoofing or asset tag cloning. Even if a visible tag such as a CQR is compromised, validation fails if the accompanying NFC tag scan is not completed within the prescribed time frame.

In some embodiments, the time interval between tag scans may be set to 60 seconds, 90 seconds, or other configurable thresholds. If the second tag is not scanned in time, the system may prompt the user to restart the verification sequence.

This timed two-tag process is useful in enterprise environments such as data centers, where high-value equipment may require verification using both a surface-printed code and an embedded radio tag.

The system may also be configured to accept combinations of tag types for two-factor verification. For example, combinations may include CQR+NFC, NFC+external ID, or CQR+external ID. Each pairing provides distinct authentication strength and use-case suitability.

In one embodiment, mobile payment terminals in a retail store may be tagged with both a printed CQR and an internal NFC chip. Employees must scan both tags during end-of-day inventory reconciliation. In another scenario, rental equipment such as audio gear may require two-tag scans before checkout. A customer scans the visual tag and presents a digital access badge containing the secondary NFC tag.

The two-tag verification flow reduces reliance on single-mode tag validation and may also help identify tampering, where one tag has been removed, swapped, or relocated. Option 159 introduces a hybrid verification mode, combining one tag scan with user authentication data. Under this model, the user must successfully scan one tag (e.g., CQR, NFC, or external ID) and also provide supporting authentication such as a user ID, biometric confirmation, or location data.

In embodiments where assets are restricted to specific users, the user ID requirement enforces role-based access. For example, only supervisors or technicians assigned to a given device pool may receive access approval when submitting their credentials along with a valid tag scan. In some cases, location data is used as the second factor. This is particularly relevant for assets restricted to geofenced areas such as secured warehouses, hospitals, or classrooms. If the tag is scanned outside the authorized location, access is denied regardless of tag validity.

This hybrid verification model supports varied authentication layers. For example, a contractor scanning a tag may be required to validate their identity using a fingerprint prompt and a pre-registered username in the application.

In another embodiment, two users may co-scan the asset. One scans the tag and another presents a secure user token, allowing controlled transfer of asset access between parties. The hybrid model can also prevent theft and misuse. For example, if a user scans a tag on a stolen asset outside its registered zone, the backend server may detect unauthorized use based on location mismatch or unrecognized user ID.

In further embodiments, facial recognition, secure passcodes, or Bluetooth-based proximity authentication may be integrated into option 159 to complement the tag scan. This approach is valuable in situations where asset control is tied to personnel accountability. Government-issued equipment, military devices, and sensitive medical kits may all benefit from user-tag hybrid authentication.

Moreover, the system may support delayed tag validation, where a tag scan is accepted only if user credentials are submitted within a defined time period. This provides temporal coherence between the two authentication elements.

The hybrid flow also allows flexible policy tuning. Organizations may permit tag-only scans during business hours and enforce full hybrid authentication during off-hours or in high-risk zones. The gateway device 151 may store partial verification attempts and send them for review if the secondary authentication fails or times out. These logs enable audit and risk scoring.

The asset verification application 155 may display contextual messages for each option. For example, for option 159, the message may state: “Scan completed. Please authenticate to proceed.” In all cases, verification outcomes from each of these workflows are packaged into POST requests and submitted to the server (143), including metadata such as timestamp, location, user ID, device signature, and tag hash.

In some embodiments, the gateway device 151 may be configured to store one or more previously authorized hash values corresponding to multimodal tags such as Certified QR (CQR) codes and NFC tag data. For example, upon successful verification of an asset via a server-based POST request, the gateway device 151 may cache a corresponding pair of hash values derived from the scanned multimodal tag (e.g., a CQR hash and an NFC hash), in association with the verified asset ID and optionally with user identifiers or location metadata. These locally stored hash values may be retained within a secure cache, memory store, or encrypted application container within the gateway device 151.

When subsequent scans of the same asset are performed by the user using the same gateway device 151, the device may extract the hash from the scanned tag data and compare it with the previously stored hash pair. If a match is found between the extracted hash and one of the locally stored hash pairs, the gateway device 151 may temporarily authorize access to the asset, permit continued interaction, or pre-approve the POST request pending further contextual checks. This embodiment may be particularly useful in offline or low-connectivity environments, where full round-trip validation with the remote server may be delayed or unavailable. In such implementations, the gateway device 151 acts as a trusted intermediary for short-term or repeated validation scenarios.

In some embodiments, local hash pair caching may be scoped to a specific user profile authenticated on the gateway device 151, such that stored hash data is only applicable to the user who originally performed the verification. In other configurations, the cached hash data may be tied to asset-specific trust policies—for example, allowing temporary reuse of a validated hash pair for a specified window of time (e.g., 30 minutes, 2 hours) or number of interactions before requiring full re-verification.

In an alternate embodiment, when a verification POST request is generated from the gateway device 151 to the server, the server may compute a time-based one-time password (TOTP) or equivalent time-synchronized cryptographic code (time-based authentication code) based on a shared secret or asset-specific key. The server may transmit this TOTP code as part of the response to the verification application 155 executing on the gateway device 151. The verification application 155 may then store this TOTP code along with a time-to-live (TTL) parameter or expiration timestamp.

Thereafter, the gateway device 151 may use the received TOTP code to authorize subsequent interactions with the asset during the TOTP validity window. For example, if the user attempts to re-access the asset or perform a configuration action, the application 155 may present the stored TOTP to the server as proof of recent verified interaction. The server may then compare the submitted TOTP against a locally generated reference TOTP based on the same shared seed and time value to validate its authenticity.

In some embodiments, the TOTP may also be displayed visually to the user within the verification application 155, allowing the user to manually input the code on a separate terminal, administrative device, or paired hardware system. This manual entry mode may be used in scenarios where distributed asset interfaces do not support direct scanning or NFC interactions but still require proof of recent authorized validation.

Additionally, the TOTP framework may support asymmetric trust propagation. For example, an administrator device may generate and distribute temporary TOTP codes to user devices for temporary asset access rights. These TOTP codes may expire after a predefined time or after single use, thereby reducing risk of long-term credential misuse.

In a further embodiment, a TOTP code may be embedded within a secondary tag temporarily linked to the asset (e.g., a disposable QR tag or portable NFC device containing the TOTP code). The verification application 155 may be configured to read this secondary TOTP tag and associate it with the original asset during verification, thereby allowing secure handover of the asset between users in controlled settings.

These local caching and time-based authentication techniques provide flexible and secure mechanisms for extending the trust lifecycle of previously validated assets, especially in edge environments, mobile scenarios, and shared-asset contexts. By reducing repeated reliance on centralized validation while maintaining secure verification, these embodiments enhance efficiency without compromising system integrity.

Referring now to FIG. 1F, a flowchart illustrates an exemplary asset verification process 160 using a multimodal tag 161 scanned by a gateway device 162, which extracts verification data and transmits a POST request 163 to a server 164 for authentication. This process 160 is applicable to physical asset tagging systems where assets are marked with scannable tags containing encoded identifiers, hashes, or verification metadata. The tag 161 may be a Certified QR (CQR), NFC, barcode, or other optical or wireless tag.

In some embodiments, the multimodal tag 161 may store one or more data elements, including a hash code, asset identifier, and verification URL. The gateway device 162 may retrieve any or all of these values upon scanning. For example, in one implementation, the tag 161 may store a raw hash code derived from a concatenated string comprising the asset ID and URL. In such a case, the hash code itself may embed the asset ID as a prefix, followed by encoded content and checksum bits, such as:
“ABC123a7f8e33d1c9efbexamplehashchecksum.”

Alternatively, in some embodiments, the tag 161 may provide only the hash code, while the verification URL may be pre-configured and stored locally within the verification application running on the gateway device 162. Upon recognizing the tag format, the gateway device 162 automatically attaches the predefined URL to the outgoing POST request 163.

The gateway device 162 may comprise a mobile phone, tablet, wearable scanner, or any network-enabled device equipped with an optical camera or NFC module. Upon scanning the multimodal tag 161, the gateway device 162 extracts and parses the encoded information to assemble a verification POST request 163.

As shown in FIG. 1F, the POST request 163 may contain a URL 163A, a hash code 163B, and optionally other data 163C. The URL 163A may be a verification endpoint such as “https://verify.example.com,” which is configured to receive asset validation requests. The hash code 163B represents the unique digital fingerprint of the asset tag, containing or referencing one or more unique identifiers.

The additional data 163C may include an authentication token derived from the gateway device 162 or its active user session. In some embodiments, the authentication token may be a username or user ID linked to a verified account logged into the device. In other embodiments, the authentication token may be a one-time code, such as a Time-Based One-Time Password (TOTP), generated or received via a secure channel.

In embodiments utilizing TOTP, the server 164 and gateway device 162 may operate using a shared seed or secret, allowing each to independently compute a synchronized one-time code valid within a narrow time window (e.g., 30 seconds). When the user initiates a scan, the gateway device 162 computes or receives the TOTP, appends it to field 163C, and transmits it alongside the hash and URL.

In an alternative embodiment, the TOTP may be generated by the server 164 and sent proactively to the gateway device 162 based on predefined authorization conditions. The application executing on the gateway device may store this code temporarily and attach it to POST requests involving sensitive asset classes.

After the POST request 163 is transmitted, the server 164 receives and parses the data, validating the hash code 163B against a database of registered assets. The server may cross-reference the hash with known hash values, comparing not only for exact match but also examining the expected asset ID or embedded metadata.

If the request contains a URL 163A that does not correspond with the known structure or hostnames authorized for a particular asset class, the server 164 may reject the request or log it as suspicious.

When additional data 163C is included, the server 164 may validate the provided authentication token or TOTP against pre-authorized user profiles. If the code has expired, is malformed, or has already been used, the server may deny access.

Upon completing validation, the server 164 transmits a response 165 back to the gateway device 162. This response 165 may indicate the status of the verification attempt, including whether the asset was found, whether the hash code matched, whether the request was submitted from a trusted user or device, and whether access is allowed. The verification result 165 may be encoded as a success or failure message, or may contain structured metadata including access permissions, user role, usage count, device compatibility, asset version, asset manual, warranty information, manufacturer information, and geographic constraints.

In the event that the POST request 163 is determined to be invalid, the server 164 may take additional action. For example, if the hash code 163B matches an asset ID but the associated location or user context is inconsistent with prior usage, the server may classify the attempt as a potential counterfeiting event.

In response to a suspected misuse or security anomaly, the server 164 may transmit an alert or escalation signal to a registered organizational or real user entity 166. This may include sending an email, push notification, or dashboard update to administrators responsible for the asset.

The real user 166 may be the owning organization, a designated administrator, or an AI-enabled monitoring system configured to take automated action. Actions may include temporarily locking the asset, revoking access tokens, or initiating deeper forensic analysis.

In certain embodiments, the server 164 may log the POST request 163 along with metadata including timestamp, IP address, gateway device identifier, GPS location, and software version. These logs may be used to build asset usage history, user activity profiles, or for post-incident analysis. In another embodiment, the POST request 163 may include location coordinates collected by the gateway device 162 during scan. This information may be compared against expected location data to determine whether the asset is being used in its authorized zone.

If the asset has a designated geofence, and the request falls outside that range, the server may reject verification even if hash and URL are valid. This is useful for preventing relocation or theft-based spoofing. The system may also detect repeated failed attempts involving the same hash code from different users or devices. If the same hash is being reused across devices or in suspicious timing sequences, the server may blacklist the hash and notify the organization 166.

In some implementations, the POST request 163 may include a session identifier linking the scan to a broader transaction, audit trail, or chain-of-custody log. This enables verification to be part of broader digital workflow.

The process flow in FIG. 1F may be executed synchronously or asynchronously. In synchronous mode, the gateway device 162 awaits a live response from the server before granting or denying access. In asynchronous mode, the scan may be logged locally and validated later when connectivity is restored.

The gateway device 162 may be preloaded with templates for constructing the POST request 163, facilitating uniform formatting and reducing the risk of malformed requests.

The asset verification process 160 is compatible with environments where tags degrade over time. The server may maintain historical hash values or expired keys to support backward compatibility or staged replacements. In some embodiments, the hash code 163B may be combined with a session nonce or salt at the time of POST request formation, improving resistance against replay attacks or code duplication. The server 164 may support AI-based validation, where timing, location, user behavior, and device characteristics are fed into a scoring model. The model may return a confidence score that determines whether to approve the verification.

For high-value or sensitive assets, the system may require dual validation—first matching the hash, then authenticating the user or device via a second factor. The gateway device 162 may be configured with fallback mechanisms in case server 164 is temporarily unavailable. For example, a set of pre-approved hash codes may be cached for short-term offline use. The multimodal tag 161 may be printed, engraved, embedded in packaging, or integrated into a tamper-proof housing. Upon being scanned, it may trigger both visual and digital verification steps.

The POST request 163 may support encryption using TLS or application-level payload signing. This protects against interception or manipulation of hash, URL, or authentication data. The organizational user 166 may configure rules for accepting or rejecting verification attempts. For example, assets used in healthcare may reject any scan not originating from whitelisted locations.

Periodic reports may be generated from accumulated scan logs, providing analytics such as most frequently scanned assets, most active users, and anomalies detected. In one embodiment, the gateway device 162 may optionally store the last successful POST request 163 and response 165. This allows continued usage during temporary disconnections while maintaining traceability. In scenarios involving shared assets, the server 164 may maintain a list of authorized user IDs allowed to interact with a given asset. The POST request 163 containing the user token will be checked against this list. The hash code 163B may also include metadata tags such as asset version, firmware, or model number, allowing the server 164 to reject obsolete or mismatched scans.

Referring now to FIG. 1G, an exemplary verification table 170 generated by the server 164 is illustrated, in accordance with some embodiments of the present disclosure. The table 170 presents multiple fields corresponding to asset validation parameters processed during scan events and verification POST requests. These parameters include an Asset ID field 171A, QR Hash comparison field 171B, NFC Hash comparison field 171C, Location permission field 171D, User ID authorization field 171E, and final Status determination field 171F.

The Asset ID field 171A identifies the unique identifier assigned to the physical asset being scanned and verified. In this example, all rows (172A-172D) reflect the same asset ID “ABC123,” indicating that multiple scan attempts were logged for the same physical item across varying conditions.

The QR Hash field 171B logs the result of comparing the hash extracted from the QR code (or CQR code) during the scan with a reference hash stored in the server's database. A “Match” in this field indicates successful recognition and integrity of the QR code.

The NFC Hash field 171C operates similarly, but for the NFC component of the multimodal tag. This field represents whether the NFC tag's hash also aligns with the stored reference. A “No Match” value may suggest tampering, tag replacement, or counterfeiting.

The Location field 171D indicates whether the scan was performed from a geographically authorized area. “Allowed” denotes that the GPS coordinates or Wi-Fi fingerprint fell within an expected zone; “Not Allowed” indicates otherwise, suggesting relocation or misuse.

The User ID field 171E reflects whether the user performing the scan was recognized and permitted to verify the asset. This value may be derived from an authenticated session, token-based login, or manual credential entry.

The Status field 171F is the final determination made by the server, based on evaluating the above conditions. It may denote “Genuine,” “Counterfeited,” “Stolen,” or a compound status such as “Genuine|Asset Moved.”

Row 172A shows a validation event for asset ABC123 where all verification parameters returned a positive result. Both QR and NFC hashes matched (171B, 171C), the scan was performed from an allowed location (171D), and the user ID was recognized as authorized (171E). The resulting status (171F) is “Genuine,” reflecting a fully trusted scan event (genuine asset). This scenario may represent a technician validating an in-place industrial sensor using an enterprise app on a registered mobile device. The asset has not been moved, tampered with, or accessed by unauthorized users.

Row 172B reflects a scan where the QR hash matches (171B), but the NFC hash fails to match the reference (171C). The location is allowed (171D), and the user is authorized (171E). However, the overall status (171F) is marked as “Counterfeited.” This configuration may occur if a QR tag was copied or cloned and placed on a counterfeit or stolen asset that lacks the original NFC component. The system detects the hash discrepancy and flags the event as suspicious. This example highlights the security advantages of multimodal verification requiring both visible and embedded tags to align to deem an asset genuine.

Row 172C shows both hash values as matching (171B, 171C) and a recognized user ID (171E), but the scan was performed from a location that is not authorized (171D=“Not Allowed”). The final status in this case is “Genuine|Asset Moved.”

This indicates that while the asset appears genuine, it has been relocated from its permitted site. Such a situation may occur when a medical kit tagged for hospital use is taken off-premises. This alerts administrators to potential unauthorized transport. The system may also log relocation history for audit or compliance purposes, especially in government, defense, or rental sectors.

Row 172D reflects a scan where both QR and NFC hashes match (171B, 171C), the scan location is allowed (171D), but the user ID is not recognized (171E=“Not Allowed”). The final status returned is “Genuine|Stolen.”

This outcome indicates that while the asset itself remains physically intact and in its authorized location, it was scanned by an unauthorized party, possibly indicating theft, impersonation, or unauthorized handover. The server (164) may escalate such a status to security personnel or asset owners (166) through real-time notifications, app alerts, or incident reporting channels.

Each field in this table is derived from verification logic running in the server backend. For example, hash matching involves deterministic comparison functions using SHA-based or HMAC algorithms with stored seed values.

Location determination is typically based on real-time GPS data, Wi-Fi triangulation, or cell tower signals reported by the gateway device. The result is matched against geofenced coordinates associated with the asset. User ID authorization may be implemented using an access control list, organizational directory, or authentication token validation process. Users not present in the allowlist may be flagged.

The final status field 171F is determined by the system's rule engine, which evaluates combinations of parameters and assigns verdicts using defined conditions. In some embodiments, the server may assign weights to the various fields. For example, a matching hash may carry higher weight than a matching location, allowing graded or probabilistic trust scoring.

The table 170 may also support extended statuses such as “Flagged for Review,” “Duplicate Scan,” or “Delayed Scan,” based on contextual factors like frequency, scan history, or behavioral anomalies. In advanced configurations, the table 170 may support integration with machine learning models that learn from historical data to identify patterns of misuse or error.

Such a model may learn that certain user-device combinations frequently yield “Not Allowed” results and prompt for stricter multi-factor checks. Each row in table 170 may be linked to additional metadata not shown here, such as timestamp, asset category, environmental data, or device identifiers used during the scan. Table 170 may be periodically exported for reporting or reviewed in real-time using a dashboard used by administrative or security personnel.

The server 164 may support audit queries such as: “Show all assets with mismatched NFC hashes this month,” using indexed views over table 170. The data structure depicted in FIG. 1G may also serve as input to inventory control systems, maintenance logging, or compliance documentation. For example, a device listed as “Genuine|Asset Moved” may automatically generate a location change approval request for supervisory review.

The QR and NFC hash match fields 171B and 171C are particularly important in environments where tag cloning is a concern, such as in consumer electronics, pharmaceuticals, or luxury goods. User ID field 171E supports traceability by linking scan actions to personnel, enabling attribution and behavior tracking. The combination of location, hash integrity, and identity authentication allows table 170 to support a triangulated approach to asset verification.

In one embodiment, scanning a tag in a valid location with mismatched hashes may yield “Counterfeited” status, while valid hashes scanned from the wrong region yield “Asset Moved.” In high-risk deployments, an asset marked “Genuine|Stolen” may immediately lock access to dependent systems, such as disabling connected machinery or remote APIs.

FIG. 1G may represent a snapshot in time or an ongoing stream of verification records processed in real time. It supports both passive monitoring and active intervention models, where failed scans may prompt alerts, requests for photo proof, or escalation workflows. Table 170 may also feed analytics modules that report daily scan volumes, regional asset status trends, or user compliance metrics. The layout of table 170 is extensible, allowing additional fields such as “Session ID,” “User Role,” or “Device Type” to be added as needed.

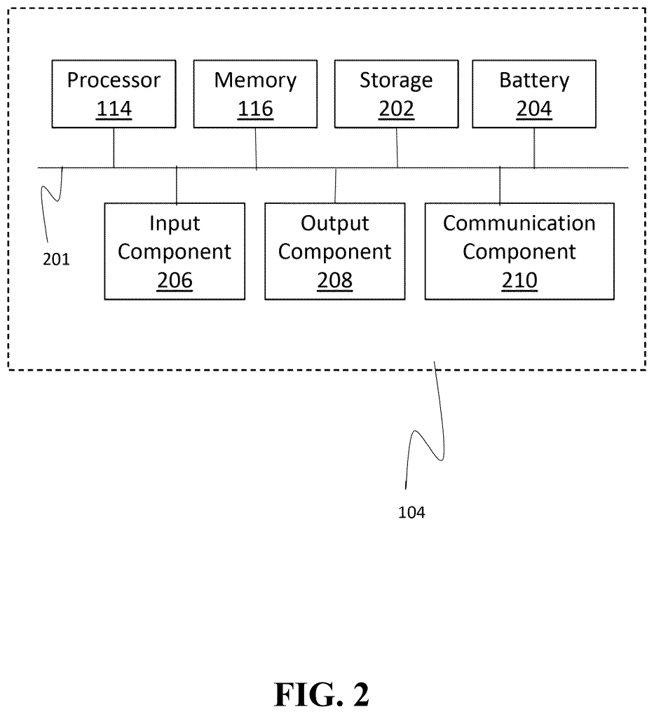

Referring now to FIG. 2, the gateway 104 may include a bus 201, a processor 114, a memory 116, a storage 202, a battery 204, an input component 206, an output component 208, and a communication interface 210. The gateway 104 may function as a portable device for multimodal tag scanning, contextual data acquisition, and real-time asset validation.

Bus 201 includes a component that permits communication among the components of gateway 104. Processor 114 is implemented in hardware, firmware, or a combination of hardware and software. Processor 114 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processor 114 includes one or more processors capable of being programmed to perform a function.

Memory 116 may include one or more memories such as a random access memory (RAM), a read only memory (ROM), and/or another type of dynamic or static storage device (e.g., a flash memory, a magnetic memory, and/or an optical memory) that stores information and/or instructions for use by processor 114.

The storage 202 stores information and/or software related to the operation and use of gateway 104. For example, storage 202 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Battery 204 is connected along bus 201 to supply power to processor 114, memory 116, and internal components of gateway 104. Battery 204 may supply power during field measurements by gateway 104. Battery 204 permits gateway 104 to be a portable integrated device for conducting field measurements of propagation delay in a RAN.

Input component 206 includes a component that permits gateway 104 to receive information, such as via user input (e.g., a touch screen display, a keyboard, a keypad, a mouse, a button, a switch, and/or a microphone). Additionally, or alternatively, input component 206 may include a sensor for sensing information (e.g., a GPS component, an accelerometer, a gyroscope, an optical sensing device including an optical sensor, scanner, or a camera, and/or an actuator).

Output component 208 includes a component that provides output information from gateway 104 (e.g., a display, a speaker, a user interface, and/or one or more light-emitting diodes (LEDs)). Output component 208 may include a display providing a GUI, such as interface. Input component 206 and output component 208 may be combined into a single component, such as a touch responsive display 118, also known as a touchscreen. Output component 208 may be used to display scan results, asset metadata, or verification alerts.

Communication interface 210 includes a transceiver-like component (e.g., a transceiver and/or a separate receiver and transmitter) that enables gateway 104 to communicate with other devices, such as via a wired connection, a wireless connection, or a combination of wired and wireless connections. Communication interface 210 may permit gateway 104 to receive information from another device and/or provide information to another device. For example, communication interface 210 may include an Ethernet interface, an optical interface, a coaxial interface, an infrared interface, an RF interface, a universal serial bus (USB) interface, a Wi-Fi interface, a cellular network interface, or the like.

Gateway 104 may perform one or more processes described herein. Gateway 104 may perform these processes by processor 114 executing software instructions stored by a non-transitory computer-readable medium, such as memory 116 and/or storage 202. A computer-readable medium is defined herein as a non-transitory memory device. A memory device includes memory space within a single physical storage device or memory space spread across multiple physical storage devices.

Software instructions may be read into memory 116 and/or storage 202 from another computer-readable medium or from another device via communication interface 210. When executed, software instructions stored in memory 116 and/or storage 202 may instruct processor 114 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, gateway 104 may include additional components, fewer components, different components, or differently arranged components than those shown in FIG. 2. Additionally, or alternatively, a set of components (e.g., one or more components) of gateway 104 may perform one or more functions described as being performed by another set of components of gateway 104.

In operation, the system 100 may function as follows. The NFC Device 102 or CQR code 120 may first be activated for tracking by operating a mobile app stored on the gateway 104. The user may initially log in and scan the tag (106), to which an object record and corresponding barcode may appear on the display 118 of the interface. Next, the user selects either an iQR or NFC tracker on the interface displayed on the display 118 of the gateway 104, and select “tag” operation to tag an object, and save the tagged object to add tracking functionality to the tag (106).

Subsequently, through either the action of the user by using an optical sensor of the gateway 104 and/or placing of the gateway 104 with the embedded NFC reader device 103 in proximity of the NFC Device 102, the processor of the gateway 104 receives data from the tag (106). Here, the processor determines whether the data is received from a CQR code label 120 or an external Identification (ID) device 122 via optical scanning by an optical sensor on the gateway 104 (e.g., a camera), or an NFC Device 102, via proximate contact with an NFC reader device 103 located within the gateway 104.

Upon determining that the data is received from the CQR code label 120, the processor proceeds to retrieve an URL including an object ID and a hash code from the COR code label 120. The processor then sends a POST request to the server 112A for validation. Here, the POST request (e.g., an API call such as “assets/{assetID}/ScanFromApp) includes the object ID, the hash code, an authentication token that attaches the POST request to an authenticated user for a log-in, a qr hash including a hash value from the URL, and a location of the gateway 104, including a latitude and a longitude at which the gateway 104 is located.

Alternatively, upon determining that the data is received from the external ID device 122, the processor retrieves an external ID unique to an item (124) within an organization. The processor then sends a POST request to the server 112A for validation. Here, the POST request (e.g., an API call such as “assets/external/ScanFromApp”) may include the external ID unique to the organization, the authentication token having an organization ID that describes the organization of a user performing a scan of the external ID device 122, and the location of the gateway 104, including the latitude and the longitude at which the gateway 104 is located.

Upon receiving the POST request, the server 112A processes the POST request. Here, the processing of the POST request includes: comparing the external ID with the organization ID of an existing object retrieved from the database 110. Upon the external ID matching the organization ID, the server 112A returns the information of the object 124 back to the user. In contrast, upon determining that the external ID fails to match the organization ID, the server 112A creates a unique object record and stores the information in the database 110.

Further, upon determining that the data is received from the NFC Device 102, the processor retrieves a Universally Unique Identifier (UUID) (i.e., a 128-bit label used for information in computer systems) of the object 124 and an NFC hash from the NFC Device 102, and sends an API request to the server 112A. Here, the API request (e.g., “device/nfc/validate”) includes parameters that include the authentication token, the location of the mobile device including the latitude and the longitude at which the gateway 104 is located, the identification of the object 124 to which the tag (106) is placed, and the NFC hash of the object 124 to which the tag (106) is placed. The gateway 104 may log the number of attempts and detect misuse based on access patterns.

Once the server 112A receives the API request, the server 112A performs a validation of the API request based on the parameters. Here, the validation involves the server 112A comparing the NFC hash from the API request from an NFC hash data (i.e., nfc_hash retrieved from the database 110). Upon a verified validation by the server 112A, the processor receives the full information associated with the object 124 from the server 112A.

The number and arrangement of devices and networks shown in FIGS. 1 and 2 above are provided as an example. In practice, there may be additional devices and/or networks, fewer devices and/or networks, different devices and/or networks, or differently arranged devices and/or networks than those shown in the figures. Furthermore, two or more devices shown in the figures may be implemented within a single device, or a single device shown in the figures may be implemented as multiple, distributed devices. Additionally, or alternatively, a set of devices (e.g., one or more devices) of the system 100 may perform one or more functions described as being performed by another set of devices of the system 100.

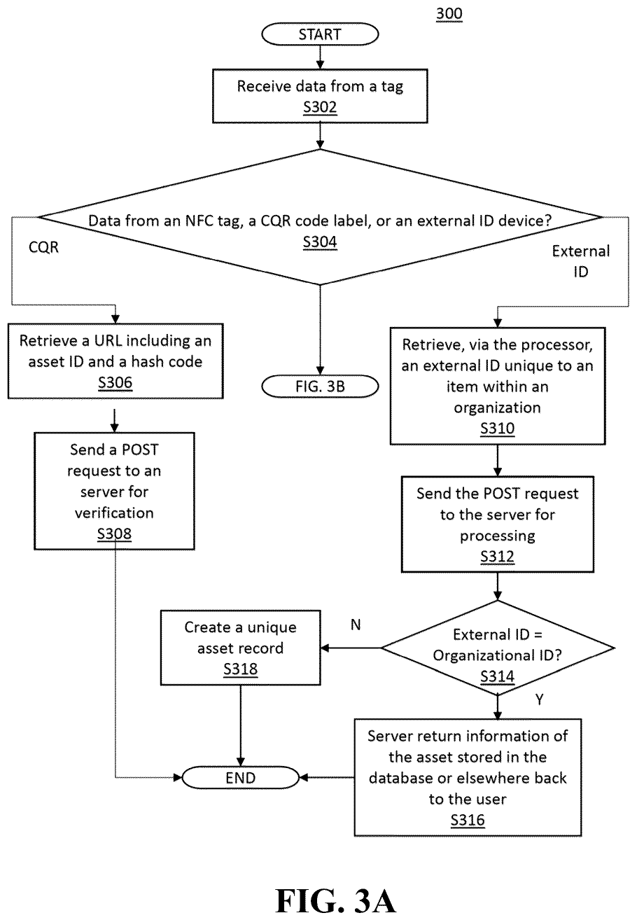

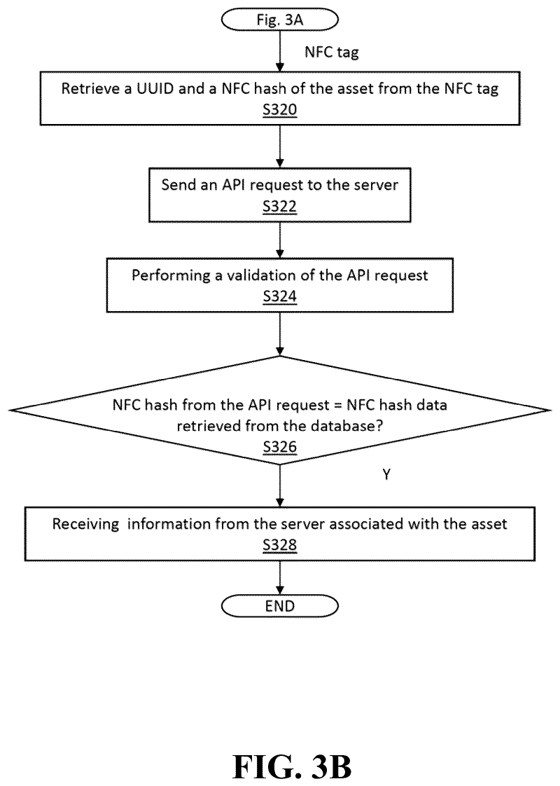

FIG. 3A and FIG. 3B show a flowchart of a method 300 of validating an object. In some implementations, one or more method step/process blocks of FIGS. 3A-3B may be performed by a processor, unless indicated otherwise. In another implementation, the method may be performed by a server. The flowchart outlines multiple branches of logic depending on the type of multimodal tag scanned—Certified QR (CQR), NFC tag, or external ID tag.

At S302, data from a multimodal tag is received by a sensor, camera, or input interface of the gateway device. The multimodal tag may be affixed to a physical object and comprise one or more of: a Certified QR code, an NFC tag, or an external ID barcode. The data acquisition may be triggered via optical scanning or proximity sensing based on the tag type.

At S304 it is determined whether the data is received from an NFC Device 102, a QR code, or an external ID device.

Upon determining that the data is received from the QR code, at S306, a URL including an object ID and a hash code is retrieved from the QR code. Next, at S308, a POST request is sent to a server. Here, the POST request may include the object ID, the hash code, an authentication token that attaches the POST request to an authenticated user for a log-in, a qr hash including a hash value from the URL, and a location of a mobile device, including a latitude and a longitude at which the mobile device is located.

Alternatively, upon determining that the data is received from the external ID device, where a format of the external ID device is in one of a 2-D barcode or a 3-D barcode, at S310 an external ID unique to an item within an organization is retrieved from the external ID device. Next, at S312, a POST request is sent to the server. Here, the POST request may include the external ID unique to the organization, the authentication token having an organization ID that describes the organization of a user performing a scan of the external ID device, and the location of the gateway, including the latitude and the longitude at which the gateway is located.

Thereafter, at S314 the POST request is processed by the server, where the external ID is compared with the organization ID of an existing object that is retrieved from a database. Upon the external ID matching the organization ID, at S316, full information of the object stored in the database is returned back to the processor and the user by the server. In contrast, upon determining that the external ID fails to match the organization ID, at S318 a unique object record is created.

Alternatively, upon determining that the data is received from the NFC Device 102, and referring to FIG. 3B, at S320 a UUID of the object and an NFC hash of the object are retrieved from the NFC Device 102. Next, at S322 an API request is sent to the server. Here, the API request may have parameters including the authentication token, the location of the mobile device, including the latitude and the longitude at which the mobile device is located, the identification of the object to which the tag is placed, and the NFC hash of the object to which the tag is placed. Thereafter, at S324 a validation of the API request is performed by the server based on the parameters sent by the processor. That is, at S326, the NFC hash from the API request is compared with an NFC hash data that is retrieved from the database. Upon a verified validation by the server (i.e., the NFC hash from the API request matches the NFC data that is retrieved from the database), at S328 the full information from the server associated with the object is received from the server.

Although FIGS. 3A and 3B show exemplary blocks of method 300, in some implementations, method 300 may include additional blocks, fewer blocks, different blocks, or differently arranged blocks than those depicted in FIGS. 3A and 3B. Additionally, or alternatively, two or more of the blocks of method 300 may be performed in parallel. This modular approach enables the system to adapt to various multimodal tag configurations while maintaining a unified verification process.

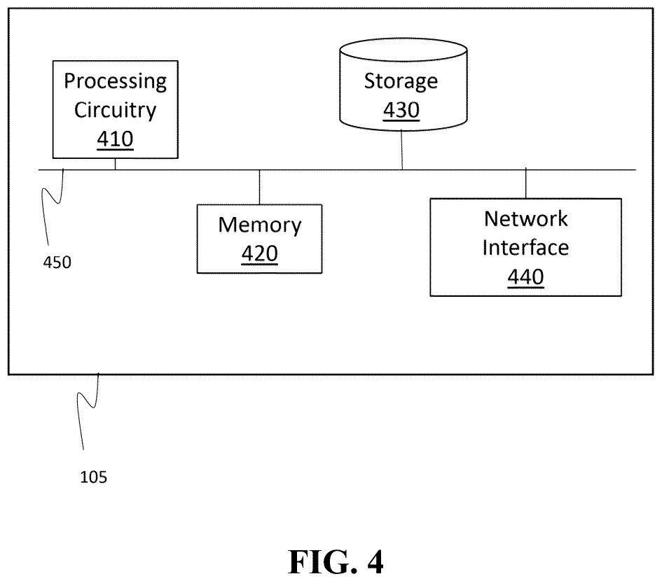

FIG. 4 is an exemplary schematic diagram of the server 105 (e.g., 112A as shown in FIG. 1) according to an embodiment. The server 105 includes a processing circuitry 410 coupled to a memory 420, a storage 430, and a network interface 440. In an embodiment, the components of the server 105 may be communicatively connected via a bus 450. The server 105 may perform asset validation operations, including hash comparison, contextual verification, access control, and logging.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 420 may be volatile (e.g., RAM, etc.), non-volatile (e.g., ROM, flash memory, etc.), or a combination thereof. In one configuration, computer readable instructions to implement one or more embodiments disclosed herein may be stored in the storage 430.

In another embodiment, the memory 420 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, CD-ROM, Digital Versatile Disks (DVDs), or any other medium which can be used to store the desired information.

The network interface 440 allows the system 100 to communicate with the gateway 104 for the purpose of, for example, receiving data, sending data, and the like. Further, the network interface 440 allows the system 100 to communicate with the database 110 for the purpose of collecting qr_hash and nfc_hash column data. In one embodiment, network interface 440 also enables secure encrypted transport via TLS/SSL protocols.

It should be understood that the embodiments described herein are not limited to the specific architecture illustrated in FIG. 4, and other architectures may be equally used without departing from the scope of the disclosed embodiments.

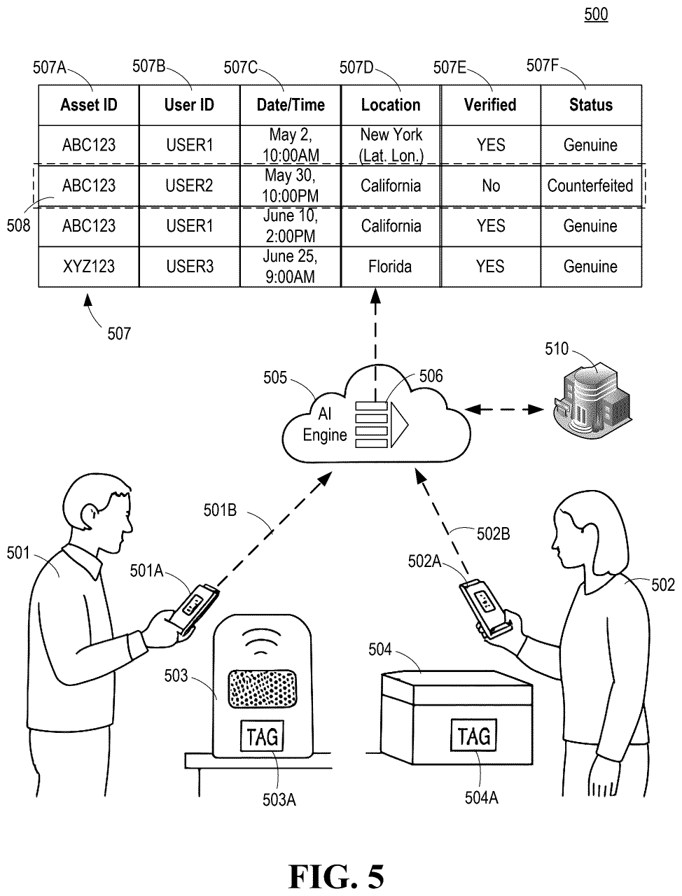

Referring now to FIG. 5, an exemplary system 500 illustrates tag-based asset validation, in which identical tags affixed to different assets may be scanned by multiple users using respective mobile gateway devices, in accordance with some embodiments of the present disclosure. The system 500 includes a first user 501 and a second user 502, each using a respective gateway device, referred to herein as the first gateway device 501A and the second gateway device 502A. Each of the gateway devices 501A and 502A may be implemented as a smartphone or a similar scanning-enabled computing device that is configured to operate a verification software application. This software application may be downloaded from or authorized by an entity such as a manufacturer, distributor, or authorized seller.

The first user 501 and the second user 502 are each interacting with respective physical assets 503 and 504. In the illustrated example, asset 503 and asset 504 may be of the same product type, such as wireless speakers. Affixed to the first asset 503 is a first tag 503A, and affixed to the second asset 504 is a second tag 504A. The tags 503A and 504A are represented (as an example) as visually identical, indicating that one of them may have been duplicated or cloned. The duplication of tags may occur as a result of counterfeit activity, in which a counterfeiter replicates a valid tag 503A from a genuine asset 503 and applies the replica tag 504A to a counterfeit asset 504, thereby misrepresenting the counterfeit asset as genuine.

The first gateway device 501A is operated by the first user 501 to scan the first tag 503A, and similarly, the second gateway device 502A is used by the second user 502 to scan the second tag 504A. Upon scanning, each gateway device 501A and 502A transmits a respective POST request 501B and 502B to a server 505 managed by an organization 510. The POST requests 501B and 502B may include data extracted from the scanned tags, such as a URL pointing to an asset verification endpoint, a unique asset identifier, and additional metadata including the user's authentication token, geolocation data, timestamp, and device signature.

The server 505 includes a verification database 506 and an AI engine configured to analyze incoming POST requests and evaluate the authenticity of the asset tags, the legitimacy of the asset-user pairing, and the contextual parameters such as scan location and frequency. The server 505 may be operated by an organization 510, such as LocatorX Inc., which may be responsible for managing product authentication infrastructure, verifying distributed assets, and identifying counterfeit activities. The AI engine in the server 505 may extract data from each POST request and performs one or more verification steps against the database 506.

The database 506 stores detailed records for each registered asset, including asset identifiers, hash values, user associations, valid geolocations, permitted usage times, and historical scan data. FIG. 5 includes a verification table 507 stored within the database 506, comprising multiple rows of scanned asset events. Each row includes columns such as asset ID 507A, user ID 507B, date/time 507C, scan location 507D, verified status 507E, and resulting status 507F (e.g., Genuine or Counterfeited 508). This verification table 507 is updated dynamically as new POST requests are received and processed.

In the example depicted, asset ID 507A “ABC123” is scanned on three different occasions: first by USER1 on May 2 at 10:00 AM in New York, then by USER2 on May 30 at 10:00 PM in California, and again by USER1 on June 10 at 2:00 PM in California. The AI engine evaluates these scans for consistency. The first and third scans by USER1 are considered valid and verified, while the second scan by USER2 is flagged as unverified and marked with the status “Counterfeited” 508. This analysis implies that tag 504A on asset 504 was duplicated from a valid tag 503A but used in an unauthorized context by an unauthorized user.

The AI engine may analyze user ID 507B in conjunction with asset ID 507A to identify whether the user initiating the scan is recognized and authorized to interact with the corresponding asset. In the present case, if USER2 has not previously interacted with or been assigned asset ABC123, the system flags the POST request 502B as originating from an unauthorized source (second user 502). This determination may further be strengthened by checking whether USER2 has ever been within a designated proximity or logistics chain associated with asset ABC123.

In addition to comparing user credentials, the AI engine may analyze the scan's geolocation data 507D to assess if the scan location is consistent with the asset's known distribution path or expected operational geography. For example, asset ABC123 may be a portable asset allowed to move between locations, but its usage is tracked. If USER1 was the original owner or authorized handler of asset 503 and has valid scans from both New York and California, this information may validate USER1's continued association with the asset. In contrast, if USER2 scans the asset in California at an unexpected time and location, and with no previous association to that asset, this may indicate a tag-cloning event.

In some embodiments, the system 500 may incorporate additional metadata analysis such as timestamp clustering, device identifiers, and scan frequency. A cloned tag often results in multiple scans with identical asset IDs but different devices, locations, or authentication tokens in a short time window. Such behavior is identifiable by the AI engine, which may trigger alerts or log anomalies in the verification table 507.

The server 505 may further be configured to issue real-time feedback to the gateway devices 501A and 502A after analysis. For example, after scanning the first tag 503A, the first user 501 may receive a confirmation message such as “Asset Verified-Genuine,” while the second user 502, after scanning the second tag 504A, may receive a warning such as “Verification Failed-Potential Counterfeit.”

In yet another embodiment, the verification table 507 may be visualized by an administrative dashboard operated by the organization 510, wherein personnel can audit scan histories, monitor flagged events, or export records for legal or compliance purposes. The dashboard may display table 507 with filtering capabilities based on asset ID, user ID, status, and location.

Each scan entry in table 507 may be used as part of a broader supply chain verification strategy. By recording and analyzing asset-user interaction events, the organization 510 is equipped to maintain visibility into distributed product usage, detect counterfeiting, and assess unauthorized access patterns.

In the depicted example, the AI engine not only detects tag duplication but can also perform behavioral analysis of user scanning patterns. If a user such as USER2 repeatedly scans various unrelated assets within a constrained time frame, the system may flag such activity for further investigation.

Server 505 may also transmit alerts or automated responses to notify product owners, asset managers, or compliance officers whenever a cloned or unauthorized scan is detected. Such alerts may be dispatched via email, push notifications, or internal monitoring systems.

The verification logic may further include risk scoring, where each scan is assigned a confidence score based on how closely the current scan context matches historical patterns. The AI engine may assign low scores to suspected counterfeits, medium scores to new but uncertain users, and high scores to verified, consistent scans.

The data architecture of system 500 may also support decentralized scanning environments. For example, authorized retailers, service centers, or inspection agents may scan asset tags independently, with all events routed back to a centralized or federated server cluster operated by organization 510.

In scenarios where asset ID duplication is suspected, the organization 510 may invoke secondary validation mechanisms, such as comparing serial number holograms, internal NFC hashes, or user-submitted photos of the physical asset taken during the scan.

Asset authenticity verification may further be linked to downstream systems such as inventory management, warranty activation, product return validation, or fraud detection services. In one embodiment, if scan 502B was identified as counterfeit, an automatic hold may be placed on processing a return request for asset 504.

The AI engine in server 505 may also learn from historical scan anomalies to strengthen its future prediction models. Each time a cloned tag is identified and confirmed, the system updates its internal feature set to improve identification accuracy over time.

In some implementations, organization 510 may operate a secure blockchain ledger storing hash representations of asset scans, enabling independent auditability and tamper resistance. The server 505 may expose APIs to third-party verification clients or consumer-facing applications to allow asset verification without compromising proprietary backend validation rules.

In an alternate embodiment, the gateway devices 501A and 502A may also capture biometric user data during scan sessions, enabling multifactor validation when determining if a scan is authorized. The asset ID 507A stored in the tag may also encode embedded metadata such as model, batch number, region, or time of manufacture. The AI engine may verify consistency of this metadata with external records.

System 500 may support offline validation workflows wherein scan data is cached locally and transmitted in bulk once network connectivity resumes. Each delayed transmission is time-stamped and analyzed in sequence. In another embodiment, tags 503A and 504A may include tamper-evident printing or physical damage detection layers, which are scanned and analyzed alongside digital data.

The depicted system architecture allows real-time interaction between physical-world scanning and cloud-based decision engines, enabling both immediate and forensic counterfeiting detection.

In a commercial implementation, an online retailer may integrate system 500 to validate asset tags at customer returns, thereby reducing restocking of counterfeit goods. From a regulatory standpoint, the logged scan history in verification table 507 may be exported and submitted to compliance authorities or brand protection units.

In the consumer domain, end users may use gateway applications to scan second-hand products and verify original manufacturer authentication based on their personal device. Each gateway device 501A and 502A may include unique device identifiers, which may be tracked in the verification database 506 to flag shared use of a compromised application or account.

In implementations where the same tag is applied to distinct assets, system 500 enables organizations to differentiate usage contexts and disassociate cloned units from genuine units. In some cases, the AI engine may receive input from computer vision modules validating product images taken at the time of scan to detect mismatched product design.

The use of an AI engine allows adaptive, non-rule-based determination of authenticity, incorporating behavior analytics, user patterns, location variability, and probabilistic reasoning. The verification table 507 may further include user notes or incident flags, allowing human reviewers to annotate suspected counterfeit records. The organization 510 may also generate asset usage analytics from verified scans, producing reports on user engagement, distribution flow, and field deployment metrics.

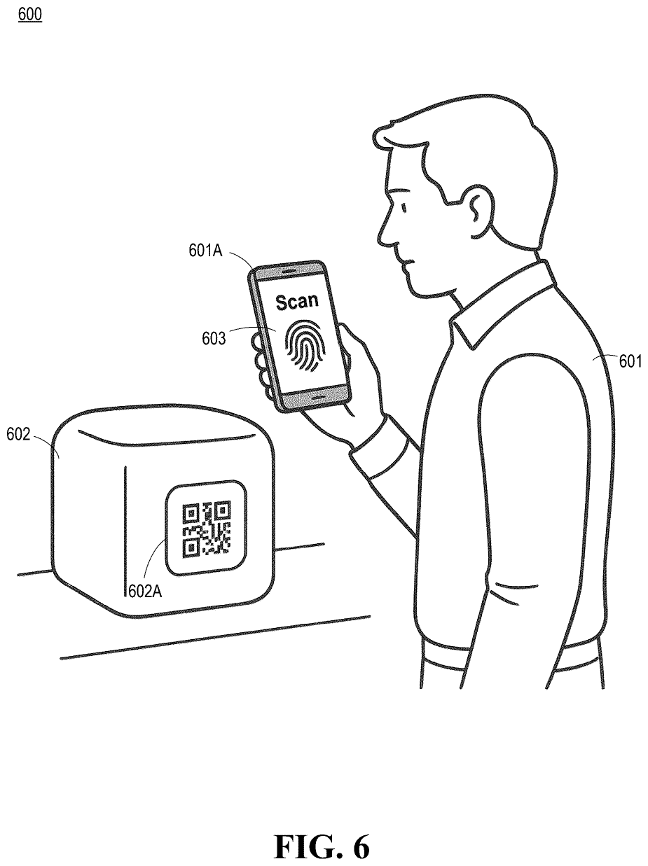

Referring now to FIG. 6, an example of asset verification illustrates that a mobile device 601A prompts for biometric authentication 603 from a user 601 during or after scanning a tag 602A affixed to an asset 602, thereby enabling a secondary layer of user-specific validation, in accordance with some embodiments of the present disclosure. The system 600 depicted in FIG. 6 enables a hybrid validation workflow wherein both the authenticity of the asset 602 and the authorization of the user 601 attempting to interact with the asset 602 are evaluated in tandem. This model enables asset-level traceability coupled with user-level accountability, strengthening asset authentication in high-risk, high-value, or sensitive environments.

In the illustrated embodiment, the user 601 holds a mobile gateway device 601A that is actively executing an asset verification application. The mobile gateway device 601A may be implemented using any handheld computing device, such as a smartphone, augmented reality (AR) device, or wearable scanner capable of reading encoded tags, capturing biometric inputs, and communicating with a remote server over a secure connection. The mobile device 601A is shown presenting a fingerprint icon and the word “Scan” on the display interface, which reflects a prompt for biometric authentication 603. This authentication may be completed using a fingerprint sensor embedded in the display surface, a physical button, or a dedicated biometric scanner integrated into the device 601A.

The asset 602 shown in FIG. 6 may be any physical item to be authenticated, verified, or access-restricted. The asset 602 includes a tag 602A affixed to its surface. The tag 602A is depicted as a QR code in this embodiment, but may alternatively be a Certified QR (CQR) code, a barcode, a 2D data matrix, an NFC tag, or a visual marker embedded with a unique pattern or machine-readable information. The tag 602A may encode data such as an asset identifier, a cryptographic hash, a redirection URL, or a digitally signed payload. Upon scanning the tag 602A, the mobile device 601A retrieves the encoded data and begins a validation process.

In some embodiments, the validation workflow initiated by scanning tag 602A may trigger an additional layer of security requiring the user 601 to authenticate their identity using biometric credential 603 before the scanned data is processed or submitted to a validation server. This biometric step may be performed prior to sending any network request, allowing the system to prevent unauthorized users from even initiating remote validation attempts. In other implementations, biometric authentication 603 may occur after the scan but before any asset data or profile information is presented to the user 601.

The biometric authentication 603 requested by the mobile device 601A may include fingerprint scanning, facial recognition, voice matching, iris detection, or any combination of such biometric modalities. In certain cases, the system may offer multi-modal biometric prompts to verify user identity with higher confidence. For example, a technician verifying access to a sensitive control panel may first provide a fingerprint and then perform a facial scan to complete the process.

Upon successful biometric authentication 603, the mobile device 601A may transmit a validation request comprising the scanned tag data, an authentication token associated with the verified user 601, device metadata, location data, and a timestamp to a backend verification server. The server may extract the asset identifier from tag 602A, compare it to a known asset registry, and verify that the authenticated user 601 is permitted to interact with or access the asset 602 under current circumstances. In some embodiments, the authentication token may be derived from the biometric authentication 603 and then sent to the server for verification analysis.

The use of biometric authentication 603 prior to submission of tag data increases resistance to fraudulent scanning attempts. If a malicious user were to physically obtain the mobile device 601A, such biometric gates would restrict their ability to initiate unauthorized scans without matching the required physical characteristics of the intended user 601.

In further embodiments, the user's biometric identity may be linked to a permissions matrix stored on the backend server, defining allowed actions per asset, time restrictions, location zones, or user roles. The server may then cross-reference the asset 602 scanned via tag 602A and verified identity of the user 601 to approve or deny access or perform further auditing actions.

The biometric prompt 603 may be dynamically triggered based on scan context. For example, if the scanned asset 602 is of high value, under transport, or has a suspicious scan history, the mobile application running on device 601A may prompt for additional biometric input regardless of user session state.

In a practical example, a government technician accessing an encrypted hard drive may scan tag 602A attached to the drive and be prompted to confirm their identity via biometric fingerprint match. Only upon successful matching of the fingerprint to a previously enrolled profile will the mobile device 601A permit the request to be sent to the cloud server.

The biometric identity captured during authentication 603 may not be stored directly, but instead may be matched locally against a securely encrypted biometric template stored within a secure enclave of the mobile device 601A. This method aligns with best practices for data protection while allowing secure identity confirmation.

The asset 602 may represent a product distributed through a controlled supply chain, such as pharmaceuticals, aviation components, or specialized test equipment. By associating user-level biometric identity to each scan, the organization managing authentication may track not only where and when an asset was scanned, but also by whom.

In another embodiment, the system may allow field operators or third-party service agents to scan assets on behalf of another account or supervisor, provided biometric authorization is confirmed and matched against a permission list preapproved by the managing entity.

The tag 602A on asset 602 may also embed a digital signature or PKI-based certificate that is decrypted during scan and used to validate tag origin. In such embodiments, biometric input 603 is used in parallel to confirm that the tag is valid and the person scanning the tag is an authorized entity.

In still further embodiments, the biometric step 603 may include behavioral biometrics such as typing speed, hand pressure, or motion-based gestures detected via the gyroscope or accelerometer within the mobile device 601A.

Asset 602 may be a fixed installation such as a wall-mounted sensor, lab device, or secured compartment that is accessed only during certain shifts or intervals. In such use cases, scan logs tied to biometric validation may allow review and auditing of access compliance.

Each biometric-authenticated scan session may be uniquely logged and assigned a session ID or validation event token, which is later referenced in audit reports, incident reviews, or regulatory filings. In some cases, the fingerprint-based biometric prompt 603 may be replaced with secure PIN input when biometric scanning fails, enabling continued access but reducing trust level scores.

The system 600 may be configured so that certain scan workflows require dual-authentication. For example, both the scanning technician and a supervising officer may each present biometric credentials before the mobile application authorizes submission of scan data. In another example, the mobile device 601A may request biometric confirmation to unlock only specific functions within the application—such as enabling tag re-assignment, tag deletion, or comment entry—following a standard scan.

Organizations using the system 600 may define global or context-specific rules for when biometric authentication 603 is triggered, such as after a set period of inactivity, at defined geographic coordinates, or upon detection of a risky scan pattern.

The prompt display shown on the screen of the mobile device 601A may also include visual cues, such as animation or color change, to signal to the user 601 whether the scan is in progress, completed, or awaiting biometric confirmation. The mobile device 601A may also retain a local encrypted record of biometric-validated scan events, which are batch-uploaded to the server when connectivity is restored.

In the event of unauthorized use attempts, such as failed biometric matches, the application may alert administrators or automatically revoke the scanning privileges of the device 601A until re-authorized.

The scan data from tag 602A, combined with user authentication 603, may also be used to generate digital certificates of possession, associating a given person with a given asset scan at a particular time and place. In industrial environments, system 600 may be deployed across factory lines, where shift workers scan assets, authenticate with biometrics, and confirm machine configurations or inventory transitions.

The biometric scan event may be combined with geolocation confirmation to form a three-factor authentication, verifying asset, user, and location before access or transaction is permitted. In one embodiment, mobile device 601A may support third-party authentication platforms (e.g., SSO, federated ID) which are initiated after local biometric validation is passed. If device 601A is shared among multiple workers, biometric step 603 facilitates that the application cannot be used anonymously, enabling traceability per scan event.

The asset 602 may also include internal sensors (e.g., temperature, motion) that log environmental data alongside each user-verified scan to offer full audit trails. Biometric authentication 603 may also allow system 600 to prevent bulk scan spoofing, where cloned tags are rapidly scanned to pollute validation logs with fake entries. The fingerprint prompt 603 may additionally serve to unlock encrypted portions of the asset metadata retrieved from the tag 602A, such as warranty, ownership, or diagnostic fields.

In environments such as airports, data centers, or laboratories, the combination of physical tag scanning and biometric user validation reduces risk of unauthorized entry or handling. System 600 may also support a privacy-protected audit model, where user identities are pseudonymized, but scan verification integrity remains auditable. The user 601 may be notified of their own biometric-based scans with summaries, warnings, or success notices to reinforce correct application use.

Multiple biometric identities may be registered per device 601A for shared-use environments, with access rules segmented by user role, such as technician vs supervisor. By requiring biometric confirmation for scans like that of tag 602A, misuse of lost or stolen devices 601A is minimized, particularly where assets 602 are of high monetary or operational value.

In retail settings, such as luxury goods counters, scan-and-verify flows with biometric authentication support in-store authentication or anti-fraud checkouts. The biometric authentication step 603 may be temporarily bypassed under “emergency mode,” subject to later audit and managerial override.

The presented architecture of system 600 creates a fusion of digital identity and physical validation, enabling comprehensive security for enterprise and consumer verification workflows. This biometric-driven workflow also empowers compliance with policies requiring not only authentication of an object (asset 602) but also verification of its human operator (user 601). As new mobile operating systems advance their biometric capabilities, the asset verification application on device 601A may continuously benefit from increased speed, accuracy, and security.

Refinements to system 600 may include biometric prompts adaptive to environmental conditions—e.g., enabling iris scan in gloves-on environments. In implementations where data protection regulations apply (e.g., GDPR), biometric data may be processed entirely on-device with no central storage, meeting policy constraints while preserving functionality.

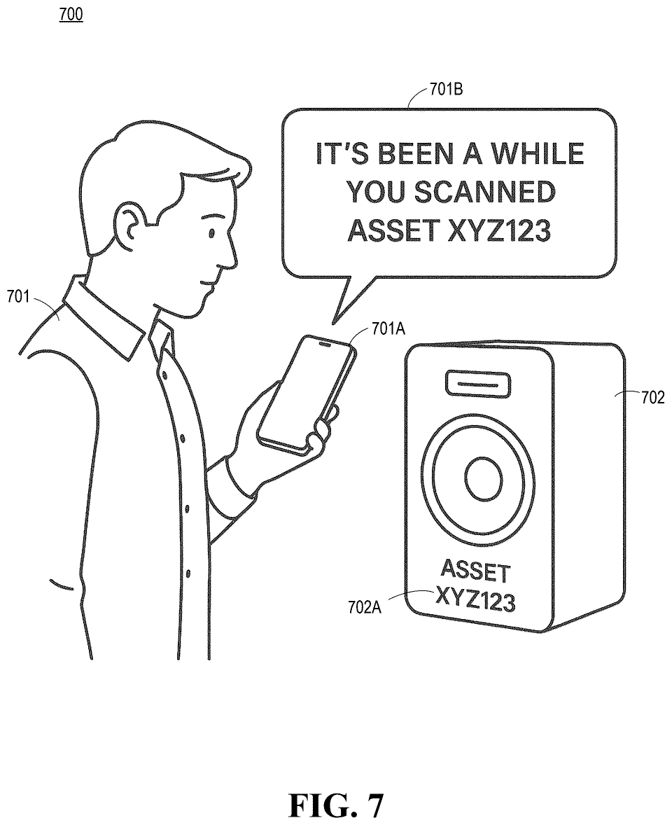

Referring now to FIG. 7, an example of a periodic asset verification system 700 is illustrated, wherein a verification prompt 701B is generated on a user device 701A, reminding a user 701 to rescan a previously validated asset 702 to maintain continued validation and monitored possession, in accordance with some embodiments of the present disclosure. The system 700 addresses a situation where an asset 702 that has been previously scanned and verified by the user 701 is subsequently stolen or transferred without authorization, and yet remains falsely treated as verified due to a lack of ongoing validation requirements.

In the illustrated embodiment, the user 701 is holding the gateway device 701A, which may be a smartphone, a tablet, or another mobile computing device capable of executing a verification software application. The device 701A displays a notification 701B, indicating a system-generated reminder that it has been a period of time since the user 701 last scanned the asset 702. The asset 702 shown in FIG. 7 is represented as a speaker-like device with a visible identifier “ASSET XYZ123” and a tag 702A affixed to its surface. The tag 702A may be a QR code, Certified QR, NFC tag, barcode, or similar scannable label encoding asset-specific data.

The periodic prompt 701B serves as a mechanism to request re-validation from a previously authenticated user 701 to confirm that the asset 702 is still in their possession and being used legitimately. In some embodiments, the system 700 may schedule such prompts based on fixed time intervals, such as daily, weekly, monthly, or custom-configured periods. The prompt 701B may be generated automatically by a remote server that monitors scan history or by the local application executing on the device 701A.

In one embodiment, after a successful verification of asset 702 via tag 702A, the server may store an association between the asset ID 702A and the user ID corresponding to user 701. If the user fails to revalidate the asset 702 within the configured period, the server may flag the asset as “validation expired” and issue reminders to the user. In such a case, the asset 702 may still appear as verified in legacy logs, but real-time interactions would show its status as pending re-validation.

To support configurable security policies, organizations deploying system 700 may define re-verification schedules per asset class. For example, high-value assets such as portable industrial devices, medical instruments, or secure communication terminals may require re-validation every 48 hours, while general consumer items may only require monthly re-checks.

The prompt 701B displayed on the device 701A may take the form of a notification banner, pop-up alert, audio signal, or vibration pattern. It may include contextual language such as the time elapsed since last scan, the asset name or type, and options to initiate a new scan or delay the verification.

The system 700 may record the exact timestamp when each periodic prompt 701B is issued, whether the user responded by scanning tag 702A, and the result of the re-validation attempt. These records may be used to generate audit logs, detect behavioral anomalies, or enforce organizational compliance policies.

If a legitimate user 701 responds to the prompt 701B and rescans tag 702A, the system 700 may update the scan history in its backend database and reset the periodic scan timer. If the user fails to respond, the system may begin escalation procedures.

In some embodiments, failure to scan asset 702 after a prompt 701B may trigger status downgrade actions, such as deactivating features of the asset, revoking software access, or sending escalation notices to administrators or compliance officers.

The verification prompt 701B may be location-aware. If the user 701 is detected within a safe or pre-approved zone, the frequency of periodic prompts may be reduced. Conversely, if the user travels to a high-risk or unfamiliar location, the system may accelerate the re-verification interval.

In another embodiment, the periodic prompts such as 701B may include a countdown clock, indicating the time left before the asset 702 is flagged as unverified. This creates urgency for the user 701 to comply with the prompt.

The prompt 701B may also include biometric re-authentication, whereby the user must first verify their identity using fingerprint, facial scan, or voice before performing the asset scan. In some implementations, system 700 may support hierarchical ownership. For example, the asset 702 may be assigned to a team rather than an individual. In such cases, re-verification may be permitted by any authorized team member, provided the system logs user credentials at the time of the scan.

The asset tag 702A may also include anti-tampering features that record physical changes to the tag or its housing. If the tag appears damaged or duplicated during re-verification, the system may block the asset. The system 700 may include logic for determining when multiple failed re-validation attempts indicate possible theft. For example, if three re-scan attempts are performed from unrelated locations or unauthorized devices, asset 702 may be flagged as compromised.

A lockout function may be triggered if a predetermined number of failed verifications is detected. For example, after five unsuccessful attempts to scan asset ID 702A, the system 700 may block any further validations and issue a warning that asset 702 has been disabled pending administrative review. In some embodiments, the user 701 may manually mark an asset 702 as stolen using the application on device 701A. This process may require the user to confirm their identity via authentication mechanisms before flagging asset ID 702A as compromised. Once flagged as stolen, asset 702 may be added to a global blocklist. Any subsequent attempt to validate tag 702A on any device triggers an alert to the system administrator and may display a warning such as “Asset Flagged as Stolen” to the scanning user.

The system 700 may maintain a registry of flagged assets, where each entry includes asset ID 702A, date of last scan, reporting user, status flag, and notes or supporting documentation submitted during the reporting process. If a stolen asset 702 is recovered, the rightful user 701 may be required to perform a re-verification and submit supporting identity documents to unblock the asset.

The prompt 701B system may include adaptive algorithms that adjust prompt frequency based on user behavior. If the user 701 has consistently validated the asset 702 over time, the system may gradually increase the re-verification window. In retail or rental scenarios, periodic prompts like 701B may be used to confirm continued possession of rented items. If the asset is not re-validated by the customer within the agreed period, late return penalties may be triggered.

Organizations implementing system 700 may visualize scan compliance metrics across users. Dashboards may indicate users who routinely ignore prompts 701B or repeatedly fail scans, helping to identify training needs or security risks. If the user 701 receives a prompt 701B and intentionally ignores it, the system may allow limited grace periods, after which the asset 702 may be disabled or suspended. The verification application on device 701A may allow users to snooze prompts or request verification extensions, provided such actions are audited and managed under policy-defined limits.

System 700 may be extended to integrate asset usage data. For example, if the asset 702 is equipped with sensors, the system may correlate usage activity with scan timing to determine if prompts are being ignored during unauthorized use. The asset tag 702A may also be dynamic in nature, such as an e-ink or programmable tag that changes display after successful verification, providing visual confirmation of re-validation status.

If asset 702 includes network connectivity, it may independently report scan status or prompt user 701 through its own interface if overdue for verification. System 700 may integrate with GPS or indoor positioning systems to validate the current location of the asset 702 during re-verification and compare it with expected zones. Each re-verification event may be assigned a unique transaction ID, digitally signed, and stored for long-term auditability.

In some embodiments, the prompt 701B may allow the user 701 to attach a contextual photo or comment with the scan, adding proof-of-presence or condition verification. Periodic verification logic in system 700 may apply to both owned and leased assets. In a leasing model, re-validation provides accountability for items under temporary custody.

The server backend may include an anomaly detection engine that flags unexpected scan intervals, repeated prompt dismissals, or unusual response patterns. Each asset 702 may be linked to a policy profile defining the frequency and response requirements for prompts 701B, enabling tailored compliance enforcement. User device 701A may also receive reward incentives for timely scan compliance, encouraging consistent user engagement with system 700.

In educational settings, periodic prompts 701B may track return of loaned devices, such as tablets or lab kits, helping institutions monitor usage and minimize losses. In large fleets, prompts 701B may be coordinated across hundreds of devices, prompting regional users to confirm physical presence of their assigned assets.

If the asset 702 is used in fieldwork, such as survey kits or mobile routers, re-verification logs help build a location trail for compliance, security, and recall purposes. To enhance privacy, system 700 may store only abstracted metadata of prompt responses, without capturing sensitive location or biometric data unless explicitly permitted.

System 700 may further include automated escalation rules whereby failed re-verifications are routed to supervisors or compliance teams with contextual event history. In some deployments, system 700 may use environmental context (e.g., accelerometer data, movement logs) to determine if assets have remained stationary for too long, triggering prompts proactively. In combination with asset usage monitoring, re-verification helps validate both possession and utilization, supporting audit readiness and operational transparency.

The verification application on device 701A may allow users to view a history of their past re-validations, upcoming prompts, and outstanding scan obligations. If integrated with organizational identity systems, user's 701 profile may be updated in real time to reflect compliance with verification prompts 701B, enabling access to higher-tier asset classes.

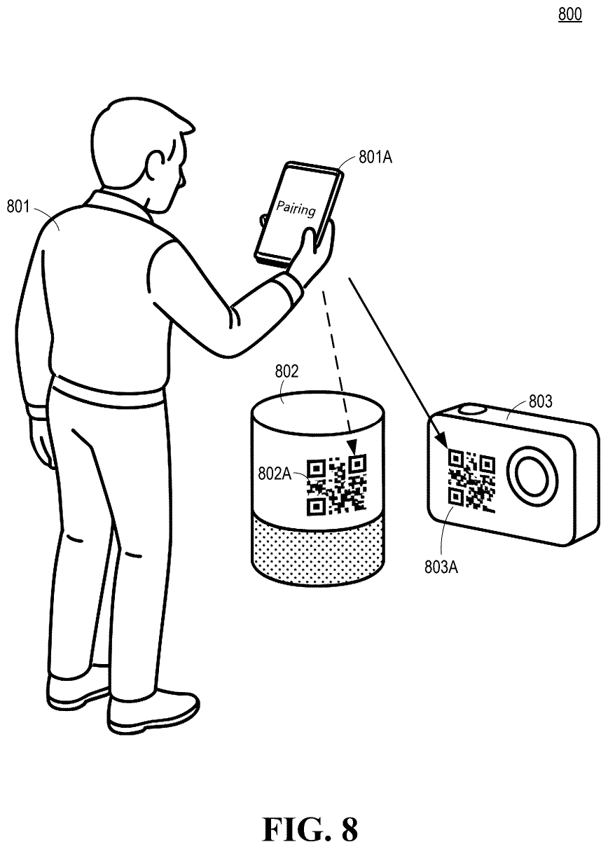

Referring now to FIG. 8, an exemplary system 800 illustrates pairing two or more devices with each other using a mobile device, wherein the pairing is based on multimodal verification of tags associated with each device, in accordance with some embodiments of the present disclosure. The system 800 includes a user 801 who interacts with a mobile gateway device 801A to initiate and complete the pairing process between a first device 802 and a second device 803. The pairing process is performed by scanning a first tag 802A affixed to the first device 802 and a second tag 803A affixed to the second device 803. The gateway device 801A may execute a verification software application that allows for asset scanning, multimodal validation, and secure pairing procedures.

In the illustrated embodiment, the first device 802 may be a wireless speaker and the second device 803 may be a media player. These devices are intended to operate together in a functional configuration, such as playing audio transmitted from the player to the speaker. However, to prevent fraudulent or unauthorized devices from connecting, the system 800 performs verification on both the first tag 802A and the second tag 803A before establishing the pairing.

The tags 802A and 803A may include various encodable formats such as QR codes, certified QR (CQR) codes, NFC tags, barcodes, or other scannable elements, each comprising unique identifiers, cryptographic hashes, authentication tokens, or redirection URLs. Each tag serves as a secure identity anchor for the respective device. The scanning of these tags by gateway device 801A enables the system to extract encoded data and initiate validation requests.

Upon scanning the first tag 802A using gateway device 801A, the mobile application may extract the asset ID of the first device 802, along with a hash value generated at manufacturing or provisioning time. This data is then temporarily stored or submitted to a remote validation server, which verifies the authenticity of the first device 802.

Following the successful verification of the first tag 802A, the user 801 may proceed to scan the second tag 803A located on the second device 803. The second scan yields another set of identity and integrity data, which is similarly validated by the system.

Once both devices 802 and 803 have been verified as genuine and registered assets in a trusted database, the gateway device 801A proceeds to complete the pairing operation. This may include the generation of a mutual association record between the two device IDs and the creation of a digital pairing certificate.

In some embodiments, the pairing certificate may be stored locally on both devices 802 and 803 or remotely on a cloud server, where future attempts to operate the devices together can be cross-referenced for pairing validity.

The verification server may additionally apply context rules during the pairing process. For example, if either of the devices is currently marked as compromised, flagged for recall, or previously associated with a blocked account, the pairing request may be denied.

In certain implementations, the system may also validate that the devices 802 and 803 are from the same manufacturing batch, model generation, or certification class before pairing is permitted. This adds a further layer of control over compatibility and counterfeit detection.

To secure the pairing event, the gateway device 801A may also associate the identity of the user 801 with the session, such as by requiring biometric or passcode authentication. This association allows later audit of who initiated the pairing and under what context. In some use cases, the paired devices 802 and 803 may transmit encrypted communication keys to each other upon pairing. These keys are generated only after successful verification of both tags 802A and 803A.

The pairing process shown in system 800 helps prevent scenarios in which a counterfeit media player 803 is used to control a legitimate speaker 802, potentially damaging brand reputation or user experience. Beyond speaker and player combinations, the system 800 may be employed to validate and pair various combinations of connected devices such as controller-sensor pairs, medical equipment with handheld interfaces, or access control readers with encrypted ID cards.

As an example, a validated infusion pump (first device 802) may be paired only with a genuine touchscreen controller (second device 803), scanned and paired by a technician 801 using a hospital-issued mobile device 801A. The pairing function may also be time-limited or context-bound. For example, a device pair may remain valid for only a specified number of sessions, hours, or geographical zones, configurable by backend policy.

Each successful pairing operation may be logged in a remote database, including device IDs, user ID 801, timestamp, and location of pairing. These records support future auditing, troubleshooting, or warranty enforcement.

In one embodiment, if a previously paired device pair (802 and 803) is later found to be involved in a security breach, the system may retroactively disable the pair by pushing a revocation signal to either or both devices. The tag validation process may also include visual confirmation, where each device displays a confirmation code or LED indicator once verified, enabling the user 801 to visually verify successful pairing.

The mobile device 801A may be configured to display step-by-step guidance during the pairing process, such as “Scan First Device,” “Scan Second Device,” and “Pairing Complete,” with accompanying progress indicators. In some scenarios, the user 801 may scan multiple devices in sequence using device 801A to create a group pairing. For example, a speaker 802, player 803, and remote controller may be grouped into a single interoperable unit. Paired devices may be locked to a particular account or enterprise identifier, such that they do not function in unauthorized environments or after unauthorized resets.

The pairing process depicted in FIG. 8 also protects against cases of mixed authenticity, where one genuine device is paired with a non-genuine device. The validation server denies such requests unless both device tags 802A and 803A are verified. Pairing logic may also validate version compatibility between devices 802 and 803, disallowing pairings between mismatched firmware or incompatible protocol stacks. System 800 supports batch pairing, where a verified user 801 scans multiple sets of devices for enterprise deployment, associating each pair for field usage.

In educational institutions, verified student-issued tablets may be paired with specific lab instruments using system 800 to track usage and prevent theft. In defense applications, verified encrypted radios may be paired with assigned operator terminals after tag verification to maintain communication security.

The verification of tags 802A and 803A may be enhanced with tamper-detection features, which alert the gateway device 801A if a tag appears altered or damaged. Once paired, devices 802 and 803 may periodically check pairing integrity using heartbeat signals validated against the pairing certificate.

System 800 may support remote unpairing, where an administrator triggers disassociation of devices 802 and 803 via backend interface, disabling their cooperation. In consumer electronics, product registration during pairing can be streamlined, collecting user info, device specs, and warranty activation in a single flow. If pairing is attempted using invalid or duplicated tags, the server may alert manufacturer fraud teams or initiate anti-counterfeit protocols.

System 800 supports multilingual prompts and accessibility features on device 801A, improving usability in global and diverse settings. The pairing certificate may be cryptographically signed and include timestamps, location data, user metadata, and device identifiers for authenticity. In autonomous vehicle fleets, verified pairing of sensor modules and control units using system 800 prevents assembly-line errors and enforces compliance.

Device pairing may also be initiated by NFC tap-to-scan, BLE handshake, or secure QR scan modes, depending on deployment conditions. For field devices lacking displays, pairing status may be communicated via LED flashes, vibration motors, or audible tones after tag validation. The gateway device 801A may support offline pairing, caching verification data and syncing with the backend server when connectivity is restored.

In scenarios involving device returns, pairing logs can verify original configuration and usage context, supporting reverse logistics and refurbishment. To enhance security, system 800 may employ location geofencing, denying pairing requests unless both devices 802 and 803 are in the same approved region. Paired devices may negotiate mutual cryptographic keys validated by the backend server to prevent spoofing or man-in-the-middle attacks post pairing. Device pairing based on tag verification promotes secure plug-and-play assembly in smart home, industrial automation, and logistics systems.

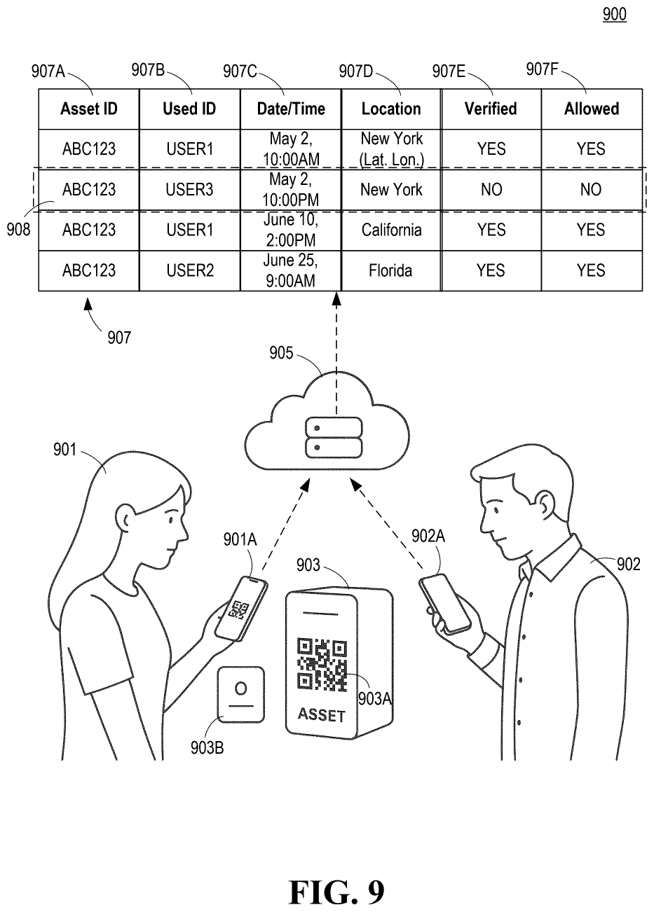

Referring now to FIG. 9, an exemplary system and method (900) is illustrated for validating an asset 903 through scans performed by multiple users 901 and 902 using separate mobile gateway devices 901A and 902A, in accordance with some embodiments of the present disclosure. The illustrated system 900 enables shared access to a tagged asset 903 by more than one authorized user under a predefined organizational policy. The asset 903 may include a multimodal tag 903A, which may take the form of a certified QR code, an NFC tag, an RFID device, or an external ID device. The system permits access control, scan-based verification, and multi-user traceability in enterprise and distributed environments.

In the depicted example, a first user 901 and a second user 902 both interact with the asset 903 and independently scan the multimodal tag 903A using respective gateway devices 901A and 902A. The verification software operating on these devices generates respective POST requests comprising tag scan data, user identity tokens, and contextual metadata such as location and timestamp. These requests are transmitted to a remote validation server 905 for processing.

The server 905 comprises a verification engine interfaced with a structured database containing a log table 907. Each POST request received from gateway devices 901A and 902A is parsed and logged into this table, which tracks verification history, user associations, and authorization status per scan. The fields in table 907 include asset ID 907A, user ID 907B, scan date/time 907C, scan location 907D, verification result 907E, and access permission outcome 907F.

In some scenarios, organizational policy may define multiple valid users for a single asset 903, such that both the first user 901 and the second user 902 are granted access or verification rights. For example, the asset 903 may be a shared field device such as a medical diagnostic unit, a rugged tablet, or a mobile data acquisition terminal issued by an organization to multiple team members.

The log table 907 shown in FIG. 9 provides evidence of this multi-user access structure. In the first row, USER1 is recorded as scanning asset ID ABC123 in New York at 10:00 AM on May 2, receiving both a successful verification (YES in 907E) and access permission (YES in 907F). The third row shows the same user scanning again from California, similarly receiving successful verification and access.

The second row, however, reveals that USER3 attempted to scan the same asset ID ABC123 from the same location (New York) on May 2 at 10:00 PM. Although the scan may have occurred at the same geographic location, the verification result was NO (907E) and access permission was denied (NO in 907F), indicating that USER3 is not an authorized user for that asset, regardless of location.

The fourth row depicts USER2 scanning from Florida on June 25 at 9:00 AM and receiving successful verification and access. This illustrates that geographical proximity alone is not a valid indicator of access rights; the decision logic resides in the backend server 905 and depends on user-role mappings maintained by the organization.

Each scan performed by users 901 and 902 is uniquely identified by a POST request and is independently validated. Even when the same asset tag 903A is scanned multiple times, the system uses the combination of asset ID, user ID, and contextual metadata to determine validity.

In some embodiments, an asset administrator such as user 901 may have permission to register additional users to a given asset. For example, after validating their own access via a scan of tag 903A, user 901 may navigate within the verification app to assign user 902 temporary or permanent access rights.

The registration of new users may require additional authentication, such as biometric confirmation, PIN entry, or access to a pre-assigned digital certificate. Once verified, user 902 may be added to an allowlist in the server 905 database.

Asset 903 may represent a hardware device managed by a corporate IT system. Once a new user is registered, they may be granted read or write permissions depending on their role. For example, some users may only query asset configuration, while others may update firmware or perform diagnostics.

In the depicted embodiment, asset 903 also includes a secondary tag 903B, which may not be physically affixed to the asset. This portable tag may reside with the team lead, issued as a digital keycard, or carried on a key fob. The tag 903B is scanned within a predetermined window in conjunction with tag 903A.

This dual-tag scanning creates a two-factor asset verification process. The system checks for the presence of both tag 903A (affixed to the asset) and tag 903B (portable and authorized), and verifies that both have been scanned within a defined time interval, such as 60 seconds.

If tag 903A is scanned without tag 903B, the system may issue a conditional warning or deny verification. This functionality prevents misuse of the asset even when tag 903A is cloned, as pairing with 903B is mandatory for completion.

The secondary tag 903B may be linked to a specific user, team, location, or operational schedule. When scanned, its data is transmitted to the server 905 and matched against known access criteria.

In some configurations, tag 903B may rotate or change per shift or project, making unauthorized replication difficult. For example, each morning the supervisor is issued a dynamic tag 903B with encrypted validity, which must accompany asset scan requests throughout the day. Secondary tags like 903B may be implemented using programmable NFC devices, encrypted QR codes, or rotating digital signatures generated by a secure mobile app.

In a warehouse scenario, asset 903 may be a forklift tagged with 903A, while 903B is a badge carried by authorized operators. Only when both the vehicle and badge are scanned within proximity will operation be allowed. The combination of user-specific access rights and physical token pairing improves asset security across various industries including logistics, defense, medical services, and education. System 900 may support delegation rights, where user 901 may not only register user 902 but also define their scope of access, such as valid scan hours, zones, and functionality tiers. Backend policy engines operating on server 905 may use logic scripts or access control lists to determine allowed users per asset, asset groups, or usage modes.

In some embodiments, access logs from table 907 may be streamed to external analytics tools for compliance reporting, user behavior modeling, or predictive maintenance. Every user and scan event may be cryptographically signed to prevent forgery or tampering, and integrity verification may be performed prior to entry into table 907. System 900 may support group-based access, where an asset 903 is accessible to all users belonging to a defined team or department, eliminating the need to register individuals. The verification logic may also incorporate device fingerprinting. If user 902 attempts to scan from a device never previously registered, server 905 may flag the attempt.

If an unauthorized scan such as that by USER3 (908) is detected, the system 900 may notify administrators via SMS, email, or push notification, or initiate automatic lockdowns. The table 907 may also include additional columns such as scan method (QR vs NFC), session token ID, or confidence score of biometric match, enriching validation granularity. For high-risk assets, the system may require simultaneous scanning of 903A and 903B by two different devices held by different users, adding co-validation security.

Secondary tag 903B may also be associated with limited lifespan, self-expiring after a defined number of uses or time window, reducing potential for misuse. System 900 may visualize relationships between users and assets as a graph, with node connections updated in real-time based on registration and scanning activity.

In educational environments, students 901 and 902 may scan to check out lab equipment 903, with tag 903B carried by a supervising faculty member who co-validates the access. In emergency services, paramedics may validate portable medical kits using dual tag scans of equipment and issued digital keys, preventing unauthorized substitution.

If tag 903A is cloned and reused by unauthorized parties, system 900 detects repeated user ID mismatches and geographic anomalies in table 907, prompting investigation. In construction, tools 903 may be tagged with 903A and accessed only if the contractor holds a project-specific NFC wristband 903B. Users such as 901 and 902 may be issued QR code credentials to access online dashboards that reflect their scan history, assigned assets, and pending authorizations. For mobile assets such as drones or field sensors, tag 903B may be carried by certified technicians, creating a virtual keyring linked to identity and role.

In some embodiments, if asset 903 has embedded connectivity, it may self-report when scanned by an unauthorized user, creating closed-loop monitoring. If multiple unauthorized users attempt to scan asset 903 within a short time, server 905 may temporarily disable all verifications for that asset and mark it as under review. The design of system 900 allows flexible multi-user management while preserving granular control, visibility, and security over each scan and validation event.

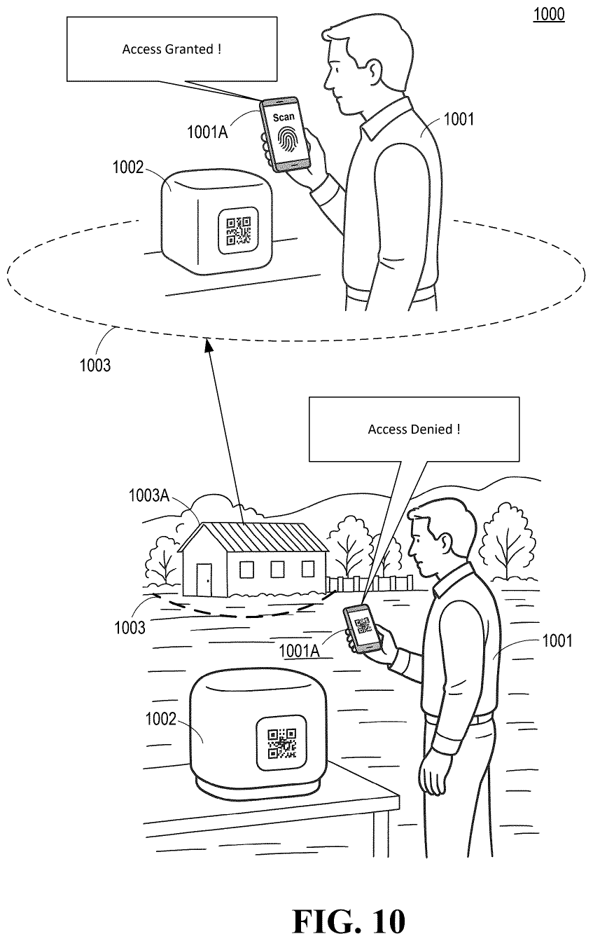

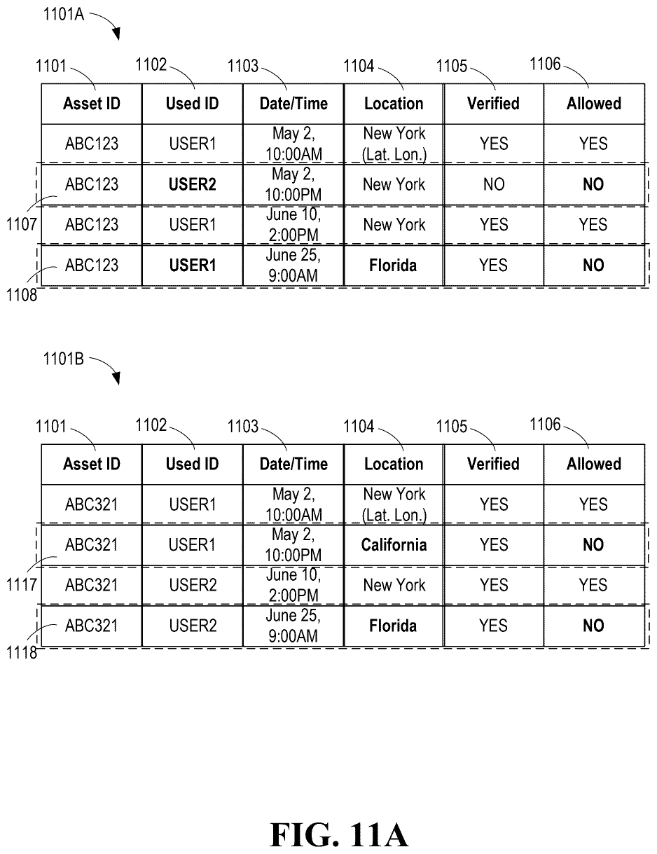

Referring now to FIG. 10, an exemplary system 1000 and method are illustrated for verifying an asset that is location-bound, in accordance with some embodiments of the present disclosure. The system 1000 includes a user 1001 interacting with an asset 1002, which is embedded with a tag. The tag may be a QR code, Certified QR (CQR), NFC tag, barcode, or external ID component that facilitates the initiation of the asset verification process via a gateway device 1001A. In the present system, verification outcomes depend not only on the authenticity of the asset 1002 and identity of the user 1001, but also on whether the scan occurs within a designated geographic boundary 1003.

In the upper half of FIG. 10, the user 1001 is depicted initiating a scan using the gateway device 1001A while being present within a predefined location perimeter 1003. This location 1003 may be defined as a geofence-a virtual perimeter implemented using GPS coordinates, Wi-Fi positioning, or beacon triangulation. The system detects the gateway device 1001A location via built-in positioning modules and compares it to the authorized boundary 1003. Upon successful match, the system renders an “Access Granted!” response, indicating that the scan is valid and the user 1001 may proceed to interact with the asset 1002.

The lower half of FIG. 10 illustrates the same user 1001 scanning the asset 1002 from outside the geofenced location 1003. Here, the location is shown relative to a physical structure 1003A, such as a home, office, school, or factory. Since the gateway device 1001A is now outside the geofenced region 1003, the system renders an “Access Denied!” message, denying the scan event regardless of user or asset validity.

The geofence 1003 may be associated with any operational environment or physical facility. In one embodiment, it may surround a residential home where a user 1001 manages access to smart appliances, such as the asset 1002 representing a connected speaker, thermostat, or backup power unit. The geofence prevents operation or configuration of such devices outside the registered home perimeter.

In another embodiment, the geofence 1003 may enclose an educational institution such as a university campus. The asset 1002 may represent a lab-grade measurement instrument or teaching apparatus, permitted to operate only when scanned within school premises.

A similar application may be found in industrial contexts, where the geofence 1003 encapsulates a warehouse or factory. The asset 1002 may be a sensor node, material handling robot, or controller, scanned and configured only when present within factory-defined zones.

The system 1000 may define geofences using polygons, circles, or complex shapes depending on facility layout. Each geofence may have multiple entry points and perimeter thresholds, adjustable by the asset management authority.

To detect presence within location 1003, the gateway device 1001A may use its onboard GPS module to retrieve latitude and longitude values. These values are then compared by a server-side engine to those of the geofence 1003. In some embodiments, the asset 1002 itself may include embedded location reporting modules. If the asset is mobile and equipped with GPS, it may transmit its own coordinates during a scan request, enabling dual-source location validation.

Access control decisions in system 1000 may depend on both static (gateway location) and dynamic (asset-reported) location inputs. A mismatch between the two may raise suspicion or trigger additional validation layers. The tag embedded in the asset 1002 may encode an asset identifier, a geofence ID, and a hash of permissible scan regions. When decoded by the gateway device 1001A, these values may be used to validate presence within an authorized area.

In one example, a medical professional attempting to access/verify a sterilized surgical instrument (asset 1002) tagged with a CQR is prompted for both biometric authentication and verified presence within a hospital operating room defined by geofence 1003. A failure to meet geofence 1003 conditions results in denial of access even if the user 1001 and the tag scan are otherwise valid. This protects asset operation and data access based on physical presence.

In retail and rental applications, system 1000 can restrict product use to specific vendor zones. An e-scooter (asset 1002) may be usable only inside a geofence 1003 representing an urban deployment boundary. Access responses may vary based on geofence proximity. While direct access is granted within 1003, users slightly outside may receive a soft warning indicating proximity to a valid zone. In high-security implementations, access outside of geofence 1003 may trigger escalation events. These may include email alerts to administrators or real-time lockdown of the asset 1002.

Organizations managing multiple sites may use geofence 1003 profiles to manage regional access to fleet assets. Each asset ID may be mapped to a list of valid geofences stored centrally. A backend validation engine may track scan frequency per geofence, identifying patterns such as repeated invalid scan attempts from outside location 1003. The gateway device 1001A may cache geofence data locally to support offline scanning, and once online, the system reconciles all scan events with live coordinates.

Assets 1002 may report whether their current scan is within the expected geofence using internal sensors. A mismatch between gateway and asset locations indicates potential tampering or relocation. Access results such as “Access Granted!” or “Access Denied!” may be logged with timestamp, user ID, asset ID, scan location, and geofence ID for forensic and compliance records.

System 1000 supports policy profiles where different users receive different geofence permissions for the same asset. For example, user 1001 may access the asset from a primary location, while a supervisor may override from elsewhere. Multiple geofences may be associated with one asset 1002. For example, a mobile testing unit may be authorized at several registered facilities defined by separate geofence identifiers.

The structure 1003A shown in FIG. 10 represents a point of reference that anchors the geofence 1003. This may be manually defined using GIS tools or automatically derived from satellite imagery. System 1000 may provide users with visual maps highlighting their current location relative to geofence 1003 to aid in compliance during field operations. Asset-specific geofence constraints may be encoded dynamically during tag provisioning. Tag 1002 may include a timestamped signature binding its operation to specific time/location pairs.

If asset 1002 is relocated improperly and scans continue outside of geofence 1003, system 1000 may automatically deactivate the asset 1002 or place it in restricted mode. In disaster response or emergency use, the geofence 1003 may be temporarily disabled by authorized override via secure admin interface. This is logged for audit. Each geofence 1003 may include a unique ID or name, helping administrators manage access at scale across multiple zones, assets, and users.

System 1000 supports geofencing in rural areas using satellite and mobile network triangulation for more reliable detection compared to GPS alone. User 1001 may receive audio or haptic feedback on gateway device 1001A based on proximity to geofence 1003 before a scan is attempted, aiding usability. The verification software may include timers that enforce maximum duration for scans outside of valid zones, e.g., allow temporary access outside geofence for 10 minutes only.

Combined with time-of-day rules, geofence 1003 can allow access during working hours only within designated facilities. Location context may be combined with usage mode. For example, read-only access may be allowed outside of geofence 1003, while configuration mode is restricted to inside. System 1000 may provide audit maps plotting asset scan events against authorized geofences to detect anomalies in deployment or usage.

Each scan denied due to geofence mismatch may generate a security flag associated with that user, helping to detect policy breaches over time. User-specific allowances may be geofenced to different levels. A technician may have broader geofence access than a contractor. Assets 1002 may support dynamic geofencing based on operational lifecycle. For example, during shipment, geofence expands; once deployed, geofence 1003 becomes strict.

Some assets 1002 may include BLE beacons as location anchors, providing more granular indoor location validation within a warehouse or hospital wing. Geofence-related access decisions can also feed machine learning systems to optimize asset placement, detect underuse, or predict logistical challenges.

If geofence 1003 is breached multiple times, the system may trigger revocation of user credentials associated with repeated violations. User's 1001 scan behavior within or outside geofence 1003 may contribute to a trust score that affects future scan validation logic. System 1000 may be integrated with external mapping systems for real-time tracking and enforcement of geofencing at global scale.

In some embodiments, two or more tags associated with a single asset may include respective hash codes that are logically coupled to each other. For example, a Certified QR (CQR) code and an NFC tag affixed to the same asset may each encode a distinct hash code that is cryptographically linked via a shared seed, derivation rule, or interdependent structure. The server may maintain a pairing record for such tags, wherein hash A (from the CQR tag) is expected to correspond with hash B (from the NFC tag) for a specific asset ID. During verification, the gateway device may scan one or both tags and transmit both hash codes to the server, where the backend logic checks not only for individual hash matches but also validates the internal correlation between the two hashes.

This coupling approach enhances security by reducing the risk of tag cloning or substitution. For example, if a counterfeiter reproduces the CQR code alone, but fails to pair it with a valid NFC hash code, the system may detect a mismatch in the coupled hash relationship and classify the asset as counterfeit. In some implementations, the two hash codes may be derived using a shared key and salt, with different input positions, such that their validation requires successful decryption or verification of both.

In further embodiments, the server incorporates an AI engine configured to learn movement patterns of the asset over time. As verification data accumulates across users, locations, and timestamps, the AI engine builds a behavioral profile for the asset that includes typical scan times, authorized users, geographic mobility range, and scan frequency. Using this learned model, the AI engine dynamically adjusts thresholds for acceptable movement between locations or time windows. For example, if an asset is historically scanned every weekday at 9:00 AM in a defined factory region, but then appears at 2:00 AM 300 miles away, the AI may classify the event as an anomaly and flag it for review.

In one illustrative example, a field technician scans both the CQR and NFC tags of a diagnostic kit using a gateway device. The hash codes are transmitted and verified against the paired entries in the server. Based on historical data, the AI engine confirms that the technician frequently verifies this asset in different factory branches across two states, with travel typically occurring in a 6-12 hour window. If a subsequent scan of the same asset occurs in a third state just 45 minutes later, the AI engine may infer logistical infeasibility and generate a warning—even if the hash codes individually validate.

Such AI-driven learning improves the system's sensitivity to context-specific movement behaviors and reduces false positives in verification decisions. The AI engine may also adapt by learning user-specific movement capabilities, such as frequent flyer behavior for traveling executives or cross-facility technicians. All movement-based insights may be used not only for verification but also for policy enforcement, asset routing optimization, and exception management.

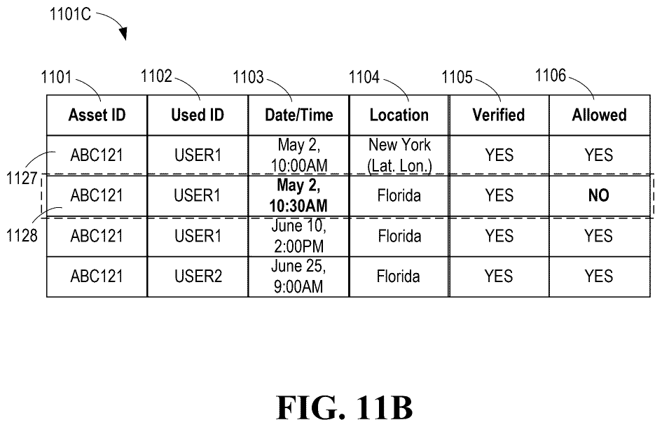

Referring now to FIGS. 11A-11B, exemplary validation tables 1101A, 1101B, and 1101C are illustrated, which may be stored, maintained, and queried by a backend server for managing scan histories and permission outcomes in accordance with various embodiments of the present disclosure. These tables reflect asset verification records involving a plurality of users and locations, and may be used by the system to evaluate the contextual eligibility of each scan request.

In FIG. 11A, the validation table 1101A comprises a plurality of fields identified as 1101 through 1106. These fields include: Asset ID 1101, User ID 1102, Date/Time of scan 1103, Scan Location 1104, Verification Result 1105, and Access Permission Result 1106. Each row of table 1101A represents a distinct asset verification event involving a specific user scanning a specific asset from a specific location at a particular time.

Table 1101A focuses on a location-bound asset identified by Asset ID “ABC123.” In this embodiment, asset ABC123 is designated by policy to be accessible and verifiable only within the geofenced location of New York. Furthermore, this asset is permitted for use exclusively by a single authorized user, identified by User ID “USER1.”

The first row in table 1101A shows a valid scan event. USER1 performed a scan of asset ABC123 on May 2 at 10:00 AM from a location identified as New York, with latitude and longitude coordinates potentially recorded as metadata. This scan was marked as Verified in field 1105 and Allowed in field 1106. This indicates that the system confirmed the authenticity of the asset, validated the identity of USER1, and determined that the scan occurred within the permitted geographic boundary for that asset.

The second row (row 1107) captures a scan attempt by USER2, a user who is not authorized to access asset ABC123. This scan occurred at 10:00 PM on the same date, May 2, from the same location—New York. Despite the location matching the authorized geofence for the asset, the system returned a result of “No” in field 1105 for Verification and “No” in field 1106 for Allowed. This demonstrates that mere location alignment is not sufficient to authorize access when the user identity does not match the approved list maintained for that asset.

The third row in table 1101A shows another scan by USER1, this time from a different location: California. This scan took place on June 10 at 2:00 PM. In this case, the system recorded a “YES” in the Verified field 1105, indicating that the asset and user were both recognized, and their credentials were valid. However, the Allowed field 1106 shows “NO,” meaning that the user was operating from an unauthorized location. The system logic in this embodiment validates user and asset authenticity separately from location constraints. While USER1 is an authorized operator of asset ABC123, their scan attempt from outside the geofenced boundary of New York triggers a restriction in access.

The fourth row (row 1108) further confirms the enforcement of geolocation rules. USER1 performed another scan on June 25 at 9:00 AM from Florida. Similar to the third row, the asset was successfully Verified, but the Allowed field was returned as “NO” due to geographic mismatch. This provides a strong example of the dual-dependency logic enforced by the system, where both user identity and physical location must align with the registered policy to receive successful scan authorization.

These rows in table 1101A illustrate how the server leverages metadata collected during asset scan attempts—including user identity, timestamp, and GPS coordinates—to render access control decisions. This type of structured logging allows for enforcement of fine-grained policies for asset verification, movement tracking, and usage rights.

In some embodiments, the verification engine running on the backend server may enforce location policies dynamically. For example, during known operational hours, location sensitivity may be relaxed for trusted users, while outside of those windows, strict enforcement is maintained.

Table 1101A reflects a model useful for enterprises managing equipment, tools, or information assets that must remain in a fixed location due to compliance, safety, or logistics constraints. Examples include chemical sensors in a factory, power distribution equipment in a substation, or hospital devices bound to a specific operating room.

The data fields such as 1105 and 1106 also provide a clear audit trail for compliance enforcement. Auditors may use this data to determine if any scans were performed by unauthorized users or from non-permitted regions.

The dual control logic shown in table 1101A also enables anomaly detection algorithms. For example, if repeated failed attempts are recorded from USER2, alerts may be generated to investigate possible credential sharing or misuse attempts.

Moreover, this logging structure supports incident analysis. If asset ABC123 was tampered with, stolen, or malfunctioned, the system administrator can look up all access attempts, their timestamps, and decision outcomes to understand the chain of custody and access context.

Each scan record may further include associated scan device identifiers, such as IMEI numbers, MAC addresses, or application version numbers, enabling additional validation layers and security profiling.

Referring now to table 1101B, it illustrates a validation record for an asset identified as ABC321, in accordance with some embodiments of the present disclosure. The table 1101B is structured with multiple columns designated by headers 1101 through 1106. These columns respectively include: Asset ID 1101, Used ID 1102, Date/Time 1103, Location 1104, Verified 1105, and Allowed 1106. Each row in the table represents a historical record of a scan or verification attempt performed by a user at a specific time and geographic location.

In this embodiment, asset ABC321 is a location-restricted asset that has been assigned to multiple users, including USER1 and USER2. The authorization logic defined in the system for this asset allows access and interaction with the asset only when scanned from within a specified geofenced location-in this case, New York. Despite being authorized users, both USER1 and USER2 are limited in their rights to verify or interact with the asset outside this permitted geolocation.

The first row of the table 1101B shows that USER1 performed a scan on May 2 at 10:00 AM from a location identified as New York. The result for this scan indicates “YES” under both Verified 1105 and Allowed 1106, meaning that the identity of USER1 and the authenticity of the asset ABC321 were verified and that the scan location met the predefined geofencing requirement. This entry is consistent with the asset's configured policy, thereby allowing full access.

The second row (row 1117) shows another scan by USER1, also on May 2, but at 10:00 PM and from a different location—California. In this case, while the Verified column 1105 still reads “YES” because USER1 and the asset ABC321 are recognized and authenticated by the system, the Allowed column 1106 reads “No.” This result implies that although the identity credentials matched and the asset was verified successfully, the system rejected the attempt due to the location being outside of the permitted geofence for asset ABC321. This illustrates the independent validation of user credentials and location compliance.

The third row of the table reflects a scan conducted by USER2, another authorized user, on June 10 at 2:00 PM from New York. The result is again positive across both fields 1105 and 1106, indicating that USER2 is authorized for asset ABC321 and that the scan occurred within the geofenced area of New York. This confirms that the system supports shared access for multiple users provided that the location constraints are also satisfied.

The fourth row (row 1118) shows a scan attempt by USER2 on June 25 at 9:00 AM from Florida. While the verification result under column 1105 still indicates “YES,” the Allowed column 1106 shows “No,” thereby denying access. This reinforces the system's location-enforcement logic even for authorized users. The separation of verification from allowance helps distinguish between user identity and contextual compliance, allowing more sophisticated access control.

The configuration demonstrated in table 1101B is relevant for use cases where mobile or portable assets are tied to specific deployment zones, but those assets are operated by rotating personnel. One example may be hospital diagnostic equipment designated for use only within a particular department or ward. USER1 and USER2 may be technicians authorized to operate the equipment, but only while stationed within the hospital zone. Another example includes tools or scanners used in secure government facilities, where geofencing prevents asset activation or access when carried outside secure premises.

The system generating table 1101B may utilize GPS data from the scanning device to determine scan location at the time of verification. In some embodiments, the system may cross-reference device-reported location with fixed boundaries stored in a centralized configuration database, such as a map overlay or geofence registry.

The use of granular verification and permission columns also supports audit logging and compliance reporting. Administrators can analyze patterns in this table to detect anomalies, such as multiple failed attempts by authorized users outside designated zones. It may also serve to identify cases where location access needs to be reviewed or updated, such as personnel reassignment to a new facility.

This format supports customizable policy enforcement, where each asset may have a distinct combination of allowed users and allowed geolocations. In more complex implementations, the system may also support temporal restrictions, where access is granted only during specific shifts, dates, or project phases.

In addition to displaying the final outcome of each scan attempt, the system backend may also store additional metadata, including network type (Wi-Fi, LTE), signal strength, scan method (manual or automated), and even confidence scores for user verification, to assist in forensic analysis or policy refinement.

Accordingly, table 1101B provides an advanced data structure that combines identity validation and spatial access control, enabling secure multi-user interactions with geographically restricted assets.

Moving to table 1101C, it illustrates a validation record for a movable asset identified as ABC121, in accordance with some embodiments of the present disclosure. Table 1101C includes multiple fields designated by headers 1101 through 1106: Asset ID 1101, Used ID 1102, Date/Time 1103, Location 1104, Verified 1105, and Allowed 1106. Each row in the table represents a logged verification attempt for asset ABC121 by one or more users from various locations.

In this embodiment, the asset ABC121 is not restricted to any particular location, meaning that it may be verified and accessed from multiple geographies as long as the verification request satisfies a set of broader contextual rules. These rules may be dynamically analyzed by an AI engine running on the backend server (e.g., as described in connection with FIG. 5). Unlike prior examples where geographic fencing dictated access eligibility, the AI-driven approach in this case evaluates user activity patterns, time intervals, and feasibility of movement to assess whether asset interactions are genuine or potentially fraudulent.

The first row (row 1127) in table 1101C shows USER1 successfully verifying and accessing asset ABC121 from New York on May 2 at 10:00 AM. The Verified column 1105 displays “YES” and the Allowed column 1106 confirms “YES,” indicating full system validation of this scan event. This establishes USER1 as an authorized user initiating a valid scan event from a permitted location.

The second row (row 1128) reflects another scan event performed by USER1 on the same day, May 2, but from Florida at 10:30 AM—30 minutes after the prior scan from New York. Although the asset and user are both verified correctly, the Allowed column 1106 shows “NO.” This outcome suggests that the AI engine evaluated the context and determined that it was physically infeasible for USER1 to travel from New York to Florida in the 30-minute window between scan events.

This temporal and spatial inconsistency leads the AI engine to treat the second scan as anomalous. The logic may infer that either the asset has been cloned and is being used simultaneously in two locations, or the user credentials have been compromised. Consequently, despite successful technical verification, access is denied to prevent unauthorized or potentially fraudulent use of the asset.

The third row shows a later scan by USER1 on June 10 at 2:00 PM from Florida. This entry is permitted (Allowed=YES) because no temporal conflicts are detected. The AI engine may have evaluated the time elapsed since the prior scan and determined that relocation of the asset from New York to Florida over that duration is entirely feasible.

The fourth row documents a scan performed by USER2 on June 25 at 9:00 AM from Florida. Both the verification and access fields are marked “YES,” confirming that USER2 was permitted to access the asset and the scan location was acceptable. In some embodiments, the asset ABC121 may be configured to allow access by multiple users or any user registered with the organization, depending on asset sharing policies.

In further embodiments, assets such as ABC121 may be part of portable deployment kits, mobile diagnostic tools, or educational kits assigned to various field operatives. These assets may not be locked to a fixed location or user and are instead monitored through behavioral intelligence and time-based consistency.

To evaluate the feasibility of each scan event, the AI engine may consider multiple factors beyond just time and location. These may include: (i) velocity calculations based on previous location and current location, (ii) known transportation routes and schedules, (iii) device metadata such as IP address, MAC address, or cellular tower data, and (iv) historical scan behavior patterns of the user.

For example, if USER1 routinely travels between New York and Florida and the scan times reflect this established pattern, the system may allow a tighter temporal threshold than for an infrequent traveler. In contrast, a sudden unexplained spike in movement speed or geographic variability may trigger access denials or additional verification steps.

The AI engine may also reference external data feeds such as airline schedules, traffic patterns, or access logs from connected assets to determine the plausibility of location transitions. For example, if a user claims to scan a mobile generator in California shortly after using it in Texas, the AI may check for supporting GPS traces or transit logs.

In another example, if a POST request for asset ABC121 is received from a geographic location known for frequent counterfeit activity, the AI engine may flag the event even if the timing appears reasonable.

The system may also weigh device authenticity. If USER1 uses different devices across scan events (e.g., new phones, unregistered devices), the AI engine may assign a lower trust score and deny access, even if location and time factors seem plausible.

In cases where asset ABC121 is open for verification by any user (e.g., public kiosks, mobile rental stations), access control may depend primarily on asset location and timing feasibility rather than user ID alone. Under this model, scanning behavior across users is evaluated for pattern consistency.

For such open-access assets, the AI engine may analyze usage density, overlap, or scan concurrency to detect cloning or theft. If two users scan the same asset from distant locations within minutes, one scan may be denied or quarantined pending investigation.

The AI system may further evaluate usage rhythm, such as the time of day when scans usually occur. A sudden scan at an odd hour or in a dormant zone may trigger denials even if user ID and location seem permissible.

In certain embodiments, verification decisions may be influenced by the user's access history with that specific asset. If USER2 is a new user scanning ABC121 for the first time, the system may enforce a more conservative threshold. In contrast, users with consistent positive scan history may be granted more flexibility, forming a dynamic trust-based access model. The system may also record failed attempts, user overrides, and device-based exceptions to refine the AI engine's future decision criteria.

In some embodiments, the server may be configured to evaluate asset verification requests by analyzing time and location data from successive scans of the same asset. Each time a scan is performed via a gateway device, the associated verification request includes not only hash values extracted from a multimodal tag, but also metadata such as the time of scan and the geographic coordinates of the gateway device. Upon receiving such a request, the server may compare the new scan event with historical scan records stored in a verification database to determine continuity, consistency, and plausibility of asset movement.

For example, if an asset labeled ABC123 is scanned in San Francisco at 9:00 AM and a subsequent scan is received at 9:45 AM from a location in Los Angeles, the server calculates the geographic distance between the two locations and evaluates the feasibility of the asset physically traveling that distance within the given time window. If the calculated speed exceeds a predetermined threshold or violates expected asset transit patterns, the server may treat the movement as infeasible.

Based on this evaluation, the server may determine whether to flag the asset as suspicious, potentially counterfeited, or unauthorized. In some cases, the asset may be marked as “Moved” if the movement is feasible but uncharacteristic. In other cases, if the scan location deviates from predefined geographic boundaries assigned to the asset, or if the movement pattern contradicts historical behavior, the server may classify the asset as “Unauthorized” or “Counterfeited.”

The server then assigns a status label to the asset based on the outcome of this analysis. The status label may be selected from a set of predefined categories including: “Genuine,” “Moved,” “Counterfeited,” “Stolen,” or “Unauthorized.” For example, if the scan is conducted by an unauthorized user from an allowed location, the server may assign a “Stolen” label. If the scan is from an allowed user and location, but the hash fails to match reference data, it may be labeled “Counterfeited.” These classifications are logged in the verification database and may be used to generate alerts, block access, or escalate the scan attempt to administrative systems for manual review.

Such an embodiment allows the verification system to go beyond simple tag validation and incorporate spatiotemporal reasoning to identify high-risk usage, clone attempts, or theft in near real time, enhancing trust and traceability in physical asset management environments.

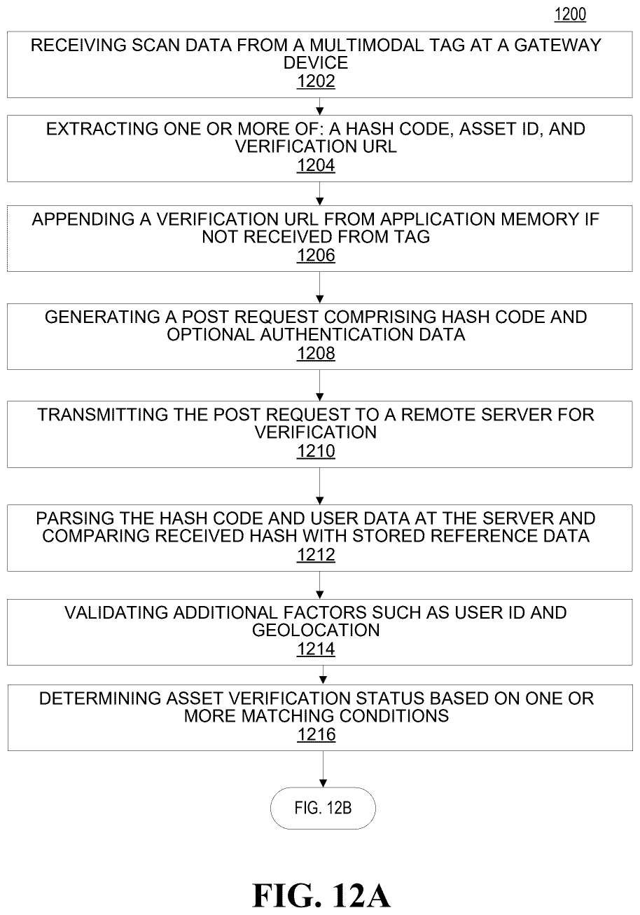

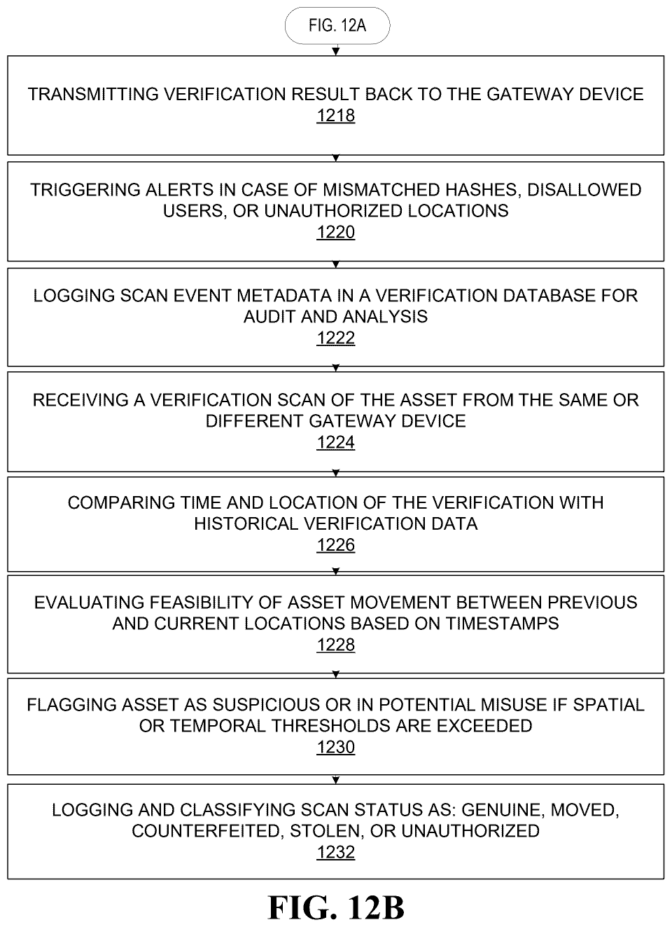

FIGS. 12A-12B illustrate an exemplary flowchart 1200 of method steps 1202 through 1232 that may be implemented in some embodiments of the present disclosure for verifying an asset using a multimodal tag and a gateway device. The method includes steps for scanning and extracting tag data, generating and transmitting a verification request to a remote server, validating the asset based on multiple contextual parameters, and classifying the verification result based on hash integrity, user authorization, geolocation, and scan behavior. The flow further includes steps for anomaly detection, logging, and status assignment to detect potential misuse, counterfeiting, or unauthorized access to the asset.

At step 1202, scan data is received from a multimodal tag at a gateway device. The multimodal tag may be a Certified QR code (CQR), an NFC tag, or a combination of tag formats embedded on or near a physical asset. The gateway device may be a mobile phone, tablet, handheld scanner, or other computing system running an asset verification application. When the user scans the multimodal tag using the gateway device's camera, NFC reader, or peripheral sensor, encoded tag data is read and transmitted to the application layer of the device. This step initiates the asset verification workflow and serves as the data acquisition point for further processing.

At step 1204, the gateway device extracts one or more of a hash code, asset ID, and verification URL from the scanned tag data. In some cases, the tag may store all three components individually. In other cases, the tag may contain only a single hash code that embeds the asset ID and a unique verification endpoint. For example, a hash string such as “ABC123-XYZ9-h8s7sd9a” may include the asset ID as a prefix and a cryptographic value encoded from both the ID and the intended URL. The application parses the tag content based on predefined decoding logic and segregates the constituent components into separate verification fields.

At step 1206, the gateway device appends a verification URL from application memory if it was not included in the scanned tag. Some tag configurations, especially those optimized for security or limited storage, may omit the full verification URL. In such instances, the asset verification application may automatically assign a preconfigured or dynamically generated URL that corresponds with the tag type, asset class, or organization's server endpoint. This URL is then attached to the verification payload to complete the data structure needed for secure server communication.

At step 1208, the gateway device generates a POST request comprising the extracted hash code and optional authentication data. The POST request is formatted according to an API specification supported by the server. In addition to the core hash code, the request may include one or more of: user credentials (such as a token, user ID, or session identifier), GPS coordinates of the device, time of scan, device signature (e.g., IMEI or MAC address), and optionally, a TOTP (time-based one-time password) if configured. This composite request structure enables the server to evaluate asset authenticity in the context of the user, time, device, and location.

At step 1210, the POST request is transmitted to a remote server for verification. The server may reside in a public cloud, private network, or be part of a federated verification infrastructure managed by the asset-owning organization. The communication may occur over a secure channel, such as HTTPS, with TLS encryption to prevent data tampering or replay. The gateway device may wait for a synchronous response or log the request for asynchronous processing depending on network conditions, server load, and configuration parameters set by the application.

At step 1212, the server receives the POST request and parses the payload to extract the hash code and any additional user data submitted from the gateway device. The hash code is compared against a database of previously registered or derived reference values. These reference hash values may have been generated during asset tagging or provisioning and may be stored along with metadata such as asset ID, organizational ownership, lifecycle state, and allowed operating zones. The server runs a deterministic comparison algorithm to check for equivalence or acceptable pattern match between the received hash and the expected value.

At step 1214, the server validates additional factors submitted with the request, such as the user ID and geolocation of the gateway device. If user credentials are present, the server checks whether the identity is registered and authorized to interact with the asset in question. If geolocation data is present, the server evaluates whether the scan occurred within a geofenced zone authorized for the asset. These additional validations help in filtering out misuse cases such as unauthorized users attempting access, or valid users scanning from invalid locations. The results of these checks are combined with hash matching results to produce a comprehensive verification response.

At step 1216, the server determines an asset verification status based on one or more matching conditions. If the hash matches the stored value, the user is authorized, and the location is allowed, the asset is marked as genuine. If only some of these conditions are satisfied, such as a hash match with unauthorized user, the asset may be flagged as genuine but stolen. If the hash does not match but location and user are authorized, the asset may be marked as counterfeit. The decision logic may be rule-based or machine learning-assisted depending on system design, and the outcome is formatted for return to the gateway device for display or further processing.

At step 1218, the verification result is transmitted back to the gateway device from the server. This result may indicate whether the asset scan has been verified successfully, flagged as invalid, or conditionally approved based on context-specific parameters. The verification result may include structured metadata such as match confidence score, asset status classification (e.g., genuine, moved, stolen), and any applicable operational restrictions. The gateway device may use this response to display a message to the user, grant or block access to the asset, or trigger application logic such as audit logging or escalation protocols.

At step 1220, the system triggers alerts in case of mismatched hashes, disallowed users, or unauthorized locations. These alerts may be pushed to organization dashboards, sent via email or SMS to designated administrators, or logged in a centralized incident management system. For example, if a scan is received from an unauthorized location while the hashes match and the user is authenticated, the alert may identify potential asset relocation. If the hash fails to match but the user and location are valid, the system may suggest tampering or counterfeit substitution.

At step 1222, scan event metadata is logged in a verification database for audit and analysis. This metadata includes but is not limited to: timestamp, gateway device identifier, user ID, asset ID, GPS coordinates, scan method, verification result, and any applicable system response. These records allow the organization to reconstruct asset access history, identify repeated patterns of misuse, and establish audit trails for compliance or forensics.

At step 1224, the system receives a verification scan of the same asset from either the same or a different gateway device. This scan may be part of a scheduled verification routine, triggered by a periodic prompt, or initiated by another user attempting to verify or access the asset. The system stores the new scan event and prepares to compare it against historical verification data to assess continuity, anomaly, or risk.

At step 1226, the system compares the time and location of the new verification scan with those of previous scans stored in historical records. This comparison helps detect asset misuse, geographic displacement, unauthorized transfer, or reappearance at an unexpected time. For example, if the same asset is scanned in California at 10:00 AM and then in New York at 10:15 AM, the system flags the sequence for further scrutiny.

At step 1228, the system evaluates the feasibility of asset movement between previous and current locations based on timestamps. This evaluation may use data such as known travel speeds, transportation routes, and physical constraints. The system may determine whether it is physically feasible for an asset to appear at the second location in the available time frame. If movement between locations appears infeasible, the system considers potential scenarios including asset duplication, tag cloning, or coordinated misuse.

At step 1230, the system flags the asset as suspicious or in potential misuse if spatial or temporal thresholds are exceeded. This may include labeling the asset status as under investigation, locking it from further interaction, or initiating multi-factor re-verification. The thresholds used for flagging may be based on configurable policies, learned behavior models, or jurisdiction-specific handling protocols.

At step 1232, the system logs and classifies the scan status using structured labels such as genuine, moved, counterfeited, stolen, or unauthorized. This classification is based on composite evaluations of hash integrity, user legitimacy, location validation, and spatiotemporal feasibility. These status labels may be presented in verification reports, stored in the asset's lifecycle history, and used to drive policy enforcement or audit preparation. The server may use this classification to prioritize investigation, restrict downstream access to the asset, or notify external systems such as ERP, inventory management, or law enforcement portals.

In some embodiments, the multimodal tag associated with an asset may comprise one or more of: a Certified Quick Response (CQR) code, a Near-Field Communication (NFC) tag, and an external ID tag. These tags may be printed, embedded, or affixed on different surfaces of the asset and encoded with distinct but interrelated data. Each tag may provide an independent hash code, which may be compared separately or as a pair during the asset verification process. For example, the CQR tag may store a QR hash code, while the NFC tag may broadcast an NFC hash code; both codes may be required to validate the authenticity of the asset during two-factor verification.

In such configurations, the hash code received at the gateway device may comprise either the QR hash code, the NFC hash code, or both. The verification server may expect both values to match corresponding reference entries in the database and may additionally validate their pairing relationship, such that hash A (QR) is cryptographically tied to hash B (NFC). Failure of either value to match or pair correctly may result in the asset being classified as counterfeited.

The authentication token included in the POST request may comprise a user identification (ID) associated with a logged-in session on the gateway device. This ID may be obtained from the verification application executing on the device, which requires a secure login process. In some embodiments, the authentication token may be a session token unique to the user's current session, generated at login and stored locally for ongoing use across multiple scans.

The POST request may also include a time-based authentication code, such as a time-based one-time password (TOTP). This TOTP may be generated by the gateway device using a shared secret and the current timestamp, or received from the server for validation. It adds a temporal security layer, preventing reuse of the same request or credential.

The verification URL appended to the POST request may be mapped to a pre-defined domain associated with an organization or manufacturer, such as verify.manufacturer.com. This domain may serve as a dedicated verification endpoint for assets produced or distributed by a specific entity, enabling centralized control.

The geolocation value of the gateway device may be captured from a GPS module integrated into the device. This value provides physical context to the verification request and may be evaluated by the server against a policy that defines allowed or disallowed geographic zones for that asset.

Upon processing the request, the server may use the verification result to control access to the asset. If verification is successful, access may be granted, such as enabling UI access to asset control features, unlocking the asset, or providing the user with asset metadata. If verification fails, interaction may be restricted or denied.

If the server detects a mismatch in the hash, an unauthorized user, or a disallowed scan location, it may trigger an alert. This alert may be sent to a monitoring system, administrative dashboard, or organizational contact to notify them of possible misuse.

The gateway device used for scanning and transmitting verification requests may be one of: a smartphone, a tablet, a dedicated handheld scanner, or a wearable device such as a smart watch or AR-enabled headset.

In another embodiment, the system may initiate a two-factor verification workflow requiring scans of two independent tags. For example, the workflow may begin with scanning the CQR tag, followed by scanning the NFC tag. Both must be completed within a predetermined time threshold (e.g., within 60 seconds) for the verification to be considered valid.

The system may also support scheduled re-verification prompts. After a predefined interval—such as daily, weekly, or monthly—the application may notify the user to re-scan the asset to confirm continued control and presence.

The POST request sent from the gateway device to the server may be encrypted using industry-standard encryption protocols, such as HTTPS with TLS 1.3, to protect the integrity and confidentiality of the transmitted data.

The server may perform role-based access control using the authentication token. For example, only users with technician or supervisor roles may be allowed to scan certain asset classes.

Assets may be restricted to specific user IDs, such as employees of a designated department. The server may maintain an access control list and compare the received authentication token against this list.

The external ID tag may be used to verify the organizational origin of the asset. For example, a logistics scanner may verify that a given package is from Organization A based on a specific external ID tag format or value.

If the hash code fails to match any known reference in the verification database, the server may classify the asset as counterfeited. This classification may prompt alerts, access denial, and tagging of the verification attempt for investigation.

In yet another embodiment, the gateway device may initiate a pairing request between two assets. The user scans the first asset and then scans a second asset using their respective multimodal tags. A pairing record is generated and logged on the server for future validation.

Some assets may be governed by location-bound policies. The server checks the GPS coordinates against configured geographic zones. If the scan location falls outside the permitted boundary, the server denies verification, regardless of hash and user authenticity.

If the hash and geolocation match, but the authentication token corresponds to an unauthorized user, the server may classify the asset as stolen. For example, if a valid scan of a stolen laptop occurs from its last known allowed location but by an unapproved user, the server flags the case.

If the hash and authentication token are valid, but the scan is submitted from an unapproved location, the server may classify the asset as moved. This status may be logged and used to update asset tracking records, trigger relocation review, or notify asset managers of unsanctioned transport.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method for verifying an asset using a multimodal tag, comprising the steps of:
a. receiving, at a gateway device, scan data from a multimodal tag associated with the asset;
b. extracting one or more of: a hash code, an asset identifier, and a verification Uniform Resource Locator (URL) from the scan data;
c. retrieving, by the gateway device, the verification URL retrieved from an application memory of the gateway device if the verification URL is not included in the scan data;
d. generating, by the gateway device, a POST request comprising the verification URL appended with the hash code and one or more of: an authentication token, a geolocation value of the gateway device, and a time-based authentication code;
e. transmitting the POST request from the gateway device to a server configured for verification processing;
f. parsing, by the server, the POST request to extract the hash code and the one or more of the authentication token, the geolocation value, and the time-based authentication code;
g. comparing, by the server, the hash code with one or more reference hash values stored in a verification database;
h. validating, by the server, one or more contextual parameters including the authentication token, the geolocation value, and the time-based authentication code; and
i. determining, by the server, a verification result based on the comparison of the hash code and validation of the one or more contextual parameters.

2. The method of claim 1, further comprising transmitting the verification result from the server to the gateway device, wherein the verification result comprises successful verification or unsuccessful verification, and wherein the verification result comprises full information of the asset in case of successful verification.

3. The method of claim 1, further comprising logging, by the server, a verification attempt with timestamp, asset identifier, gateway device identifier, and the verification result.

4. The method of claim 1, further comprising, upon receipt of a subsequent scan for the asset, comparing time and location of the subsequent scan with previous scan records stored in the verification database.

5. The method of claim 4, further comprising evaluation, by the server, a feasibility of asset movement between locations based on timestamps and geographic distance.

6. The method of claim 5, geographic distance determining, by the server, whether to flag the asset as suspicious, counterfeited, moved, or unauthorized based on the evaluation.

7. The method of claim 6, geographic distance classifying and storing a status label for the asset based on the determination, wherein the status label comprises one or more of: genuine, moved, counterfeited, stolen, or unauthorized.

8. The method of claim 1, wherein the multimodal tag comprises one or more of: a Certified Quick Response (CQR) code, a Near-field communication (NFC) tag, and an external ID tag.

9. The method of claim 1, wherein the hash code comprises one or both of: a QR hash code and an NFC hash code.

10. The method of claim 1, wherein the authentication token comprises a user identification (ID) retrieved from an authenticated session on the gateway device.

11. The method of claim 1, wherein the authentication token is a session token assigned to a logged-in user of a verification application.

12. The method of claim 1, wherein the time-based authentication code is a time-based one-time password (TOTP).

13. The method of claim 1, wherein the verification URL is mapped to a pre-defined domain associated with an organization or manufacturer.

14. The method of claim 1, wherein the geolocation value of the gateway device is retrieved from a GPS module within the gateway device.

15. The method of claim 1, wherein the verification result is used to allow or restrict interaction with the asset.

16. The method of claim 1, wherein the server triggers an alert when one or more of: hash mismatch, unauthorized user, or unauthorized location is detected.

17. The method of claim 1, wherein the gateway device comprises one of: a smartphone, a tablet, a dedicated handheld scanner, and a wearable device.

18. The method of claim 1, further comprising initiating a two-factor verification workflow requiring two independent tag scans.

19. The method of claim 18, wherein the two-factor verification workflow requires a QR code scan followed by an NFC tag scan.

20. The method of claim 18, wherein the two-factor verification workflow requires a second scan to occur within a predetermined time threshold from a first scan.

21. The method of claim 1, further comprising initiating user re-verification of the asset after a predefined interval.

22. The method of claim 1, further comprising encrypting the POST request prior to transmission to the server.

23. The method of claim 1, wherein the server performs role-based access control of the asset based on the authentication token.

24. The method of claim 1, wherein the asset is restricted to specific user IDs stored in an access control list.

25. The method of claim 8, wherein the external ID tag is associated with a specific organization and used to validate an organizational origin of the asset.

26. The method of claim 1, wherein the server is configured to detect and classify the asset as counterfeited when the hash code fails to match any of the one or more reference hash values stored in the verification database.

27. The method of claim 1, wherein the gateway device initiates a pairing request between two or more assets by scanning a first multimodal tag and a second multimodal tag.

28. The method of claim 1, wherein the asset is associated with a location-bound policy stored in the server and verification is denied if the geolocation value of the gateway device does not fall within an allowed location boundary.

29. The method of claim 1, wherein the server marks the asset as stolen when the hash code and geolocation value match expected values, but the authentication token corresponds to an unauthorized user.

30. The method of claim 1, wherein the server classifies the asset as moved when the hash code and the authentication token are valid, but the geolocation value is outside a designated location.

31. A method of validating an asset, comprising:
receiving, via a sensor, data from a multimodal tag comprising a wireless communicator and a visible indicator;
determining, via a processor, whether the data is received from a NFC Device 102, a QR code, or an external Identification (ID) device, wherein the NFC Device 102 includes a memory of at least 144 bytes that is adapted to store one of an identification of the asset, is of an ISO Format of ISO15693, and is one of an NFC-V or a TYPE-5 NFC;
upon determining that the data is received from the QR code, performing:
retrieving, via the processor, a URL including an asset ID and a hash code;
sending, via the processor, a POST request to an endpoint, the POST request including:
the asset ID;
the hash code;
an authentication token that attaches the POST request to an authenticated user for a log-in;
a qr hash including a hash value from the URL; and
a location of a mobile device, including a latitude and a longitude at which the mobile device is located;
upon determining that the data is received from the external ID device, wherein a format of the external ID device is in one of a 2-D barcode or a 3-D barcode, performing:
retrieving, via the processor, an external ID unique to an item within an organization;
sending, via the processor, the POST request to the endpoint, the POST request including:
an external ID unique to the organization;
the authentication token having an organization ID that describes the organization of a user performing a scan of the external ID device; and
the location of the mobile device, including the latitude and the longitude at which the mobile device is located;
processing, by the endpoint, the POST request, wherein the processing of the POST request includes:
comparing the external ID with the organization ID of an existing asset retrieved from a database, wherein:
upon the external ID matching the organization ID, returning information of the asset back to the user; and
upon determining that the external ID fails to match the organization ID, creating a unique asset record;
upon determining that the data is received from the NFC Device 102, performing:
retrieving, via the processor, a UUID of the asset, and an NFC hash of the asset;
sending, via the processor, an API request to the endpoint, the API request including parameters including:
the authentication token;
the location of the mobile device, including the latitude and the longitude at which the mobile device is located;
the identification of the asset to which the multimodal tag is placed; and
the NFC hash of the asset to which the multimodal tag is placed;
performing a validation of the API request by the endpoint based on the parameters, the validation comprising:
comparing, by the endpoint, the NFC hash from the API request from an NFC hash data retrieved from the database; and
upon a verified validation by the endpoint, receiving, via a server, a full information from the endpoint associated with the asset.
